(19) United States
(12) Patent Application Publication
(10) Pub. No.: US 2026/0331142 A1
(43) Pub. Date: Oct. 22, 2026

(54) GENERALIZED SWITCH FRAMES

(71) Applicant: NETFLIX, INC., Los Gatos, CA (US)

(72) Inventors: Kyle Christopher SWANSON, Los Gatos, CA (US); Andrey NORKIN, Campbell, CA (US)

(21) Appl. No.: 19/415,560

(22) Filed: Dec. 10, 2025

Related U.S. Application Data
(60) Provisional application No. 63/792,222, filed on Apr. 21, 2025.

(51) Int. Cl. G11B 27/34; H04N 19/105; H04N 19/503; H04N 19/70; H04N 19/82

(52) U.S. Cl. CPC G11B 27/34; H04N 19/105; H04N 19/503; H04N 19/70; H04N 19/82

(57) ABSTRACT

Techniques are disclosed for generating and decoding switch frames in a video-coding bitstream to enable controlled stream switching and random access playback. An encoder determines switch points between encodes and generates switch frames that include explicit signaling defining reference-frame preservation information across each switch point. The explicit signaling specifies which reference frames in a decoded picture buffer are to be preserved or refreshed, thereby maintaining consistent reference states across encodes and reducing bandwidth and processing overhead. Switch frames can include generalized switch frames that selectively preserve inter-referenced frames or random access switch frames that depend on a keyframe for decoding. A decoder receives the bitstream, parses the explicit signaling from each switch frame, updates the decoded picture buffer according to the indicated preservation information, and reconstructs the decoded pictures for seamless playback.

### CROSS- REFERENCE TO RELATED APPLICATIONS

The present application claims the benefit of U.S. Provisional Application titled, “TECHNIQUES FOR IMPLEMENTING GENERALIZED SWITCHING FRAMES,” filed on Apr. 21, 2025, and having Serial No. 63/792,222. The subject matter of this related application is hereby incorporated herein by reference.

### BACKGROUND

### Field of the Invention

Embodiments of the present disclosure relate generally to computer science and video processing and, more specifically, to generalized switch frames.

### Description of the Related Art

Streaming video platforms deliver encoded video as a sequence of frames to client playback applications. An encoder generates multiple encodes at different bitrates and resolutions, which are divided into video sequences for delivery. Client playback applications dynamically switch between such encodes based on network conditions or device capabilities. Each video sequence includes different types of frames. A keyframe is a self-contained frame that can be decoded independently. Reference frames are stored in a decoded picture buffer (DPB) and reused for inter-frame prediction. An inter-frame depends on previously decoded reference frames. To enable switching between encodes, certain encoders generate switch frames, herein referred to as switch frames.

Conventional switch frames are inserted at designated switch points determined by the encoder for switching between encodes. The encoder generates conventional switch frames to reset the DPB and establish a consistent set of reference frames at the switch point. If a decoder encounters a switch frame, then the decoder refreshes the DPB according to predefined rules. In such a manner, conventional switch frames provide the decoder with a DPB state that allows playback to continue after a switch and enable smooth decoding when transitioning between encodes.

One drawback of the approach involving conventional switch frames is the limitation in controlling how the DPB is updated. Conventional switch frames refresh the DPB in a fixed manner and do not selectively preserve reference frames across a switch point. As a result, reference frames that are not shown but remain useful for inter-frame prediction are discarded. This discarding of non-shown reference frames leads to increased bandwidth consumption and increased encoder and decoder processing load, as additional keyframes must be transmitted and decoded instead of reusing preserved reference frames. Another drawback of conventional switch frames is that the DPB contents at a switch point can differ across encodes, which causes different DPB states. The use of conventional switch frames requires each encode to independently refresh the DPB, resulting in different DPB states at the same switch point. Such different DPB states cause the decoder to encounter mismatched preserved reference frames when switching between encodes, resulting in visible artifacts during playback.

Another drawback of the foregoing approach is that conventional switch frames lack support for random access. Random access refers to the ability of the decoder to begin playback at an arbitrary random access point in the bitstream. Because conventional switch frames cannot be decoded using only a keyframe as a dependency, random access points are restricted to keyframes. Enabling multiple random access points requires frequent use of keyframes, which are larger in data size and thus increase network bandwidth requirements. A further drawback is inefficiency in decoder processing. Specifically, conventional switch frames require the decoder to apply fixed logic DPB update policies when updating reference frames, where the decoder refreshes and reorders reference frames in a fixed sequence without encoder control. The decoder relies on fixed logic to infer which reference frames to update or discard. Consequently, the encoder cannot explicitly designate which reference frames to preserve across the switch point, which limits flexibility in stream switching.

As the foregoing illustrates, what is needed in the art are more effective techniques for implementing switch frames.

### SUMMARY OF THE EMBODIMENTS

In some embodiments, a method for encoding switch frames in a bitstream comprises determining a plurality of switch points for transition between a plurality of encodes included in a video stream; and for each switch point included in the plurality of switch points: encoding a switch frame that includes explicit signaling defining reference-frame preservation across the switch point; and inserting the switch frame into the bitstream to cause a decoder receiving the bitstream to apply the explicit signaling to update a decoded picture buffer in accordance with the defined reference-frame preservation.

In some embodiments, a method for decoding switch frames included in a bitstream comprises receiving a bitstream that includes a plurality of switch frames, each switch frame comprising explicit signaling defining reference-frame preservation information across a corresponding switch point; and for each switch frame included in the plurality of switch frames: parsing the explicit signaling included in the switch frame to identify reference frames to be preserved and reference frames to be refreshed across the corresponding switch point; and updating a decoded picture buffer in accordance with the identified reference frames to be preserved and the identified reference frames to be refreshed.

Other embodiments of the present disclosure include, without limitation, one or more computer-readable media including instructions for performing one or more aspects of the disclosed techniques as well as a computing device for performing one or more aspects of the disclosed techniques.

At least one technical advantage of the disclosed techniques relative to the prior art is that the disclosed techniques enable DPB update control at switch points by the encoder. Explicit DPB update control by the encoder allows for a preservation of selected reference frames across the switch point and avoids discarding non-shown reference frames. Preservation of reference frames reduces network bandwidth consumption and reduces processing load on the encoder and the decoder. Another technical advantage of the disclosed techniques over the prior art is that the disclosed techniques maintain consistent DPB states across encodes at switch points. Consistent DPB states prevent mismatched reference frames during a transition between encodes, which avoids visible artifacts during stream switching and increases reliability across encodes.

A further technical advantage of the disclosed techniques is that the disclosed techniques provide random access points that do not rely only on keyframes. Additional random access points improve video startup behavior and video seeking behavior without increasing the frequency of keyframes in the encode, which reduces network bandwidth consumption during playback. An additional technical advantage of the disclosed techniques is that the disclosed techniques simplify decoder management of the DPB by shifting update decisions to the encoder. Shifting DPB update decisions to the encoder ensures uniform DPB updates across decoders for a given encode, which increases reliability and reduces error propagation after a switch point.

These technical advantages represent one or more technological advancements over prior art approaches.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates a network infrastructure used to distribute content to content servers and endpoint devices, according to various embodiments.

FIG. 2 is a conceptual illustration of various frames and associated fields processed by the encoder and the decoder of the system of FIG. 1, according to various embodiments.

FIG. 3 is a more detailed illustration of the encoder for generation of the generalized switch frames and the random access switch frames of FIG. 2, according to various embodiments.

FIG. 4 is a more detailed illustration of the decoder for decoding the generalized switch frames and the random access switch frames of FIG. 2, according to various embodiments.

FIG. 5 illustrates a flow diagram of a method for generation of a generalized switch frame and a random access switch frame within a bitstream of an encoder, according to various embodiments.

FIG. 6A illustrates a flow diagram of a method for decoding of a generalized switch frame and a random access switch frame via a decoder, according to various embodiments.

FIG. 6B illustrates a flow diagram of a method for decoding a random access switch frame at a random access point, according to various embodiments.

FIG. 7 illustrates a flow diagram of a method for updating a DPB based on a current frame, according to various embodiments.

FIG. 8 is a more detailed illustration of a computing device that can implement the functionalities of the entities illustrated in FIG. 1, according to various embodiments.

### DETAILED DESCRIPTION

In the following description, numerous specific details are set forth to provide a more thorough understanding of the present disclosure. However, it will be apparent to one skilled in the art that the present disclosure may be practiced without one or more of these specific details.

As described herein, streaming video platforms deliver encoded video as sequences of frames generated by an encoder that generates multiple encodes at different bitrates and resolutions for delivery to client playback applications, which dynamically switch between encodes based on network conditions or device capabilities. Each video sequence includes keyframes that can be decoded independently, reference frames stored in a decoded picture buffer (DPB) for inter-frame prediction, and inter-frames that depend on previously decoded reference frames. To enable switching between encodes, encoders generate switch frames inserted at designated switch points to reset the DPB and establish a consistent set of reference frames so that the decoder can refresh the DPB and continue playback smoothly.

However, conventional switch frames refresh the DPB in a fixed manner and do not selectively preserve reference frames across a switch point, which causes useful non-shown reference frames to be discarded, increases bandwidth and processing load, and may lead to mismatched DPB states across encodes that cause visible artifacts during playback. In addition, conventional switch frames lack support for random access since they cannot be decoded solely from a keyframe, thereby restricting random access points to keyframes and increasing bandwidth due to the frequent use of large keyframes. Further, because conventional switch frames rely on fixed DPB update logic within the decoder, the encoder cannot explicitly control which reference frames are preserved or discarded across a switch point, limiting flexibility in stream switching.

Accordingly, the disclosed techniques provide generalized switch frames, also referred to herein as switch frames, within a streaming pipeline that includes an encoder and a decoder. The encoder generates a bitstream that includes generalized switch frames and random access switch frames at designated switch points across encodes. The generalized switch frame includes a preservation flag that enables explicit DPB update control by identifying reference frames to preserve and reference frames to refresh across a switch point. The random access switch frame enables random access playback at the switch point by relying on a keyframe as a reference.

The encoder selects switch points, designates each switch point to use the generalized switch frame or the random access switch frame, sets a preservation flag, and coordinates preserved reference frames across the encodes to maintain consistent DPB states. The encoder writes signaling in the bitstream that identifies a frame type and carries the preservation flag. The decoder receives the bitstream, parses the signaling for a current frame, and decodes the current frame using reference frames or keyframes indicated by signaling information carried by the switch frame. The decoder then updates the DPB according to the current frame type. For a normal frame, the decoder inserts the decoded frame according to a normal update policy. Normal frames refer to keyframes, inter frames, and intra-only frames that utilize default reference-selection rules and default decoded picture buffer update policies without switch-specific signaling. Such normal frames decode and update the decoded picture buffer according to conventional rules and do not apply explicit reference-frame preservation signaling. In contrast to normal frames, the generalized switch frames include explicit signaling that directs decoded picture buffer update behavior across a switch point and overrides default reference-selection rules. For the generalized switch frame, the decoder applies the preservation flag to preserve specified reference frames, refreshes remaining DPB entries, and inserts the decoded frame according to a generalized switch frame policy. For the random access switch frame, the decoder obtains and decodes the dependency keyframe, applies the preservation flag to preserve the dependency keyframe, and inserts the decoded random access switch frame according to a random access policy.

At least one technical advantage of the disclosed techniques relative to the prior art is that the disclosed techniques enable DPB update control at switch points by the encoder. Explicit DPB update control by the encoder allows for a preservation of selected reference frames across the switch point and avoids discarding non-shown reference frames. Preservation of reference frames reduces network bandwidth consumption and reduces processing load on the encoder and the decoder. Another technical advantage of the disclosed techniques over the prior art is that the disclosed techniques maintain consistent DPB states across encodes at switch points. Consistent DPB states prevent mismatched reference frames during a transition between encodes, which avoids visible artifacts during stream switching and increases reliability across encodes.

A further technical advantage of the disclosed techniques is that the disclosed techniques provide random access points that do not rely only on keyframes. Additional random access points improve video startup behavior and video seeking behavior without increasing the frequency of keyframes in the encode, which reduces network bandwidth consumption during playback. An additional technical advantage of the disclosed techniques is that the disclosed techniques simplify decoder management of the DPB by shifting update decisions to the encoder. Shifting DPB update decisions to the encoder ensures uniform DPB updates across decoders for a given encode, which increases reliability and reduces error propagation after a switch point.

These technical advantages represent one or more technological advancements over prior art approaches.

### System Overview

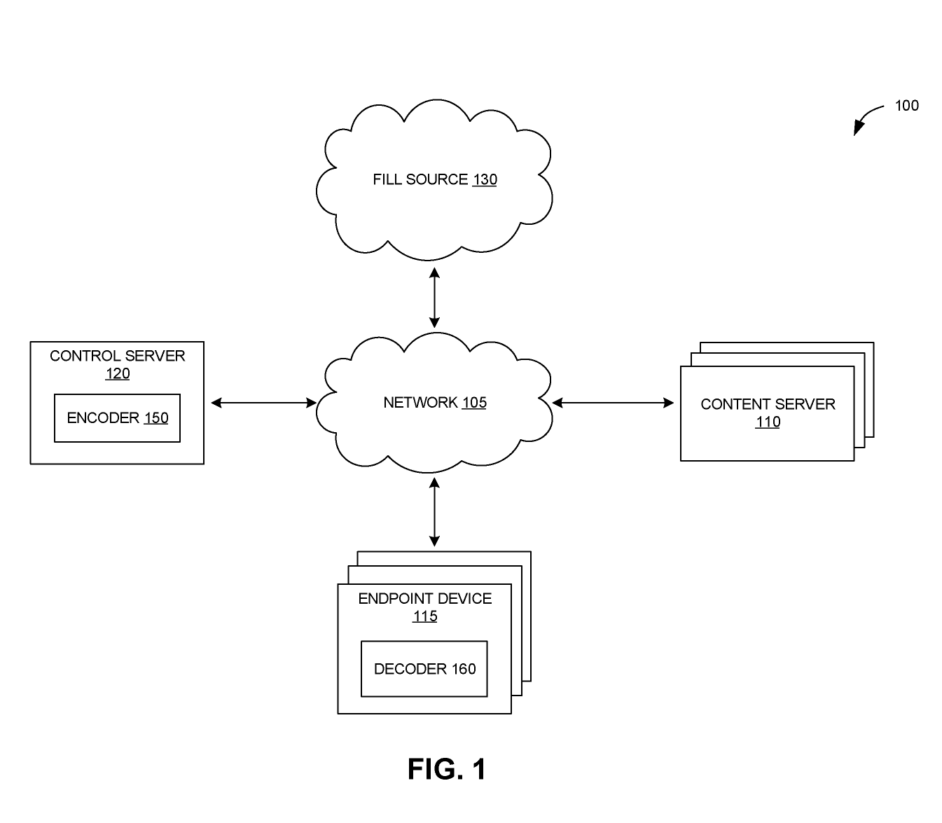

FIG. 1 illustrates a network infrastructure 100 used to distribute content to content servers 110 and endpoint devices 115, according to various embodiments. As shown, the network infrastructure 100 includes content servers 110, a control server 120, fill sources 130, and endpoint devices 115, each of which is connected via a communications network 105. The control server 120 includes, without limitation, an encoder 150. The endpoint device includes, without limitation, a decoder 160.

Each endpoint device 115 communicates with one or more content servers 110 (also referred to as “caches” or “nodes”) via the network 105 to download content such as textual data, graphical data, audio data, video data, and other types of data. The downloadable content, also referred to herein as a “file,” is then presented to a user of one or more endpoint devices 115. In various embodiments, the endpoint devices 115 may include computer systems, set-top boxes, mobile computers, smartphones, tablets, console and handheld video game systems, digital video recorders (DVRs), DVD players, connected digital TVs, dedicated media streaming devices (e.g., the Roku® set-top box), and/or any other technically feasible computing platform that has network connectivity and is capable of presenting content such as text, images, video, and/or audio content to a user.

Each content server 110 may include a web server, database, and server application (not illustrated in FIG. 1) configured to communicate with the control server 120 to determine the location and availability of various files that are tracked and managed by the control server 120. Each content server 110 may further communicate with the fill sources 130 and one or more other content servers 110 to “fill” each content server 110 with copies of various files. In addition, content servers 110 may respond to requests for files received from endpoint devices 115. The files may then be distributed from the content servers 110 or via a broader content distribution network. In some embodiments, content servers 110 enable users to authenticate (e.g., using a username and password) to access files stored on content servers 110. Although only a single control server 120 is shown in FIG. 1, in various embodiments multiple control servers 120 may be implemented to track and manage files.

In various embodiments, the fill source 130 may include an online storage service (e.g., Amazon® Simple Storage Service, Google® Cloud Storage, etc.) in which a catalog of files, including thousands or millions of files, is stored and accessed to fill the content servers 110. Although only a single fill source 130 is shown in FIG. 1, in various embodiments multiple fill sources 130 may be implemented to service requests for files. Further, as is well understood, any cloud-based services can be included in the architecture of FIG. 1 beyond fill source 130 to the extent desired or necessary.

Although FIG. 1 illustrates the encoder 150 as residing within the control server 120, in various embodiments the encoder 150 can be implemented in other elements of the network infrastructure 100 whilst still residing within the scope of this disclosure. For example, the encoder 150 can be included within the fill source 130 or directly on one or more of the content servers 110. The encoder 150 can also be distributed across multiple components such that different modules of the encoder 150 operate on different components. Any such arrangement remains within the scope of the present.

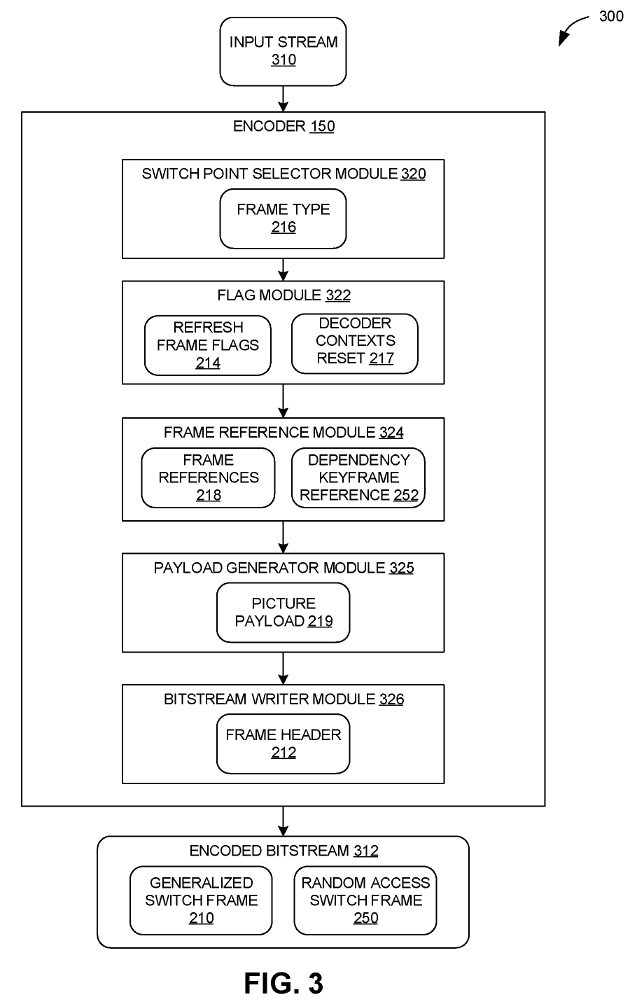

The encoder 150 first receives an input stream from the fill source 130. The input stream can include audio, video, or other multimedia data that requires transformation into a coded bitstream for distribution. Upon receipt, the encoder 150 performs preprocessing operations to prepare the input stream for compression. Such preprocessing operations can include resolution normalization, frame alignment, audio and video synchronization, and format conversion into an internal representation that is compatible with subsequent modules described in further detail below in conjunction with FIG. 3.

The encoder 150 then executes steps that involve generating a switch frame, including selecting a switch point, inserting refresh frame flags, inserting frame references, generating a picture payload, and writing a bitstream. These steps are discussed in further detail below in conjunction with FIG. 3.

The encoder 150 then applies compression algorithms to generate an encoded bitstream. In various embodiments, the encoder 150 executes motion estimation, prediction, transformation, and quantization steps. The bitstream is structured such that frames are classified according to frame types, enabling efficient inter-prediction and random access functionality when decoded by the decoder 160.

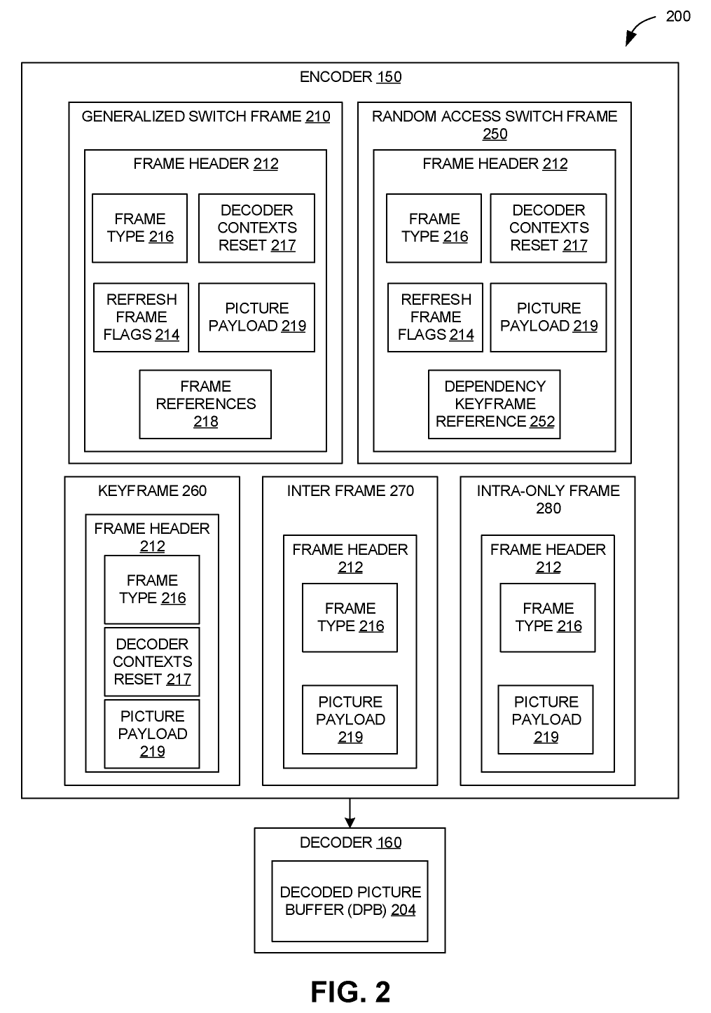

In various embodiments, the encoder 150 communicates with the control server 120 during the encoding process. The encoder can receive information from the control server 120 such as an encode policy, a service policy, and picture metrics, described in further detail below in conjunction with FIG. 2.

In some embodiments, the encoder 150 transmits the encoded bitstream through the network 105 for storage at one or more of the content servers 110 and playback at the endpoint devices 115. The encoded bitstream can include conventional frame types, generalized switch frames, and random access switch frames that include explicit signaling that is recognizable by the decoder 160, discussed further in detail in conjunction with FIG. 2.

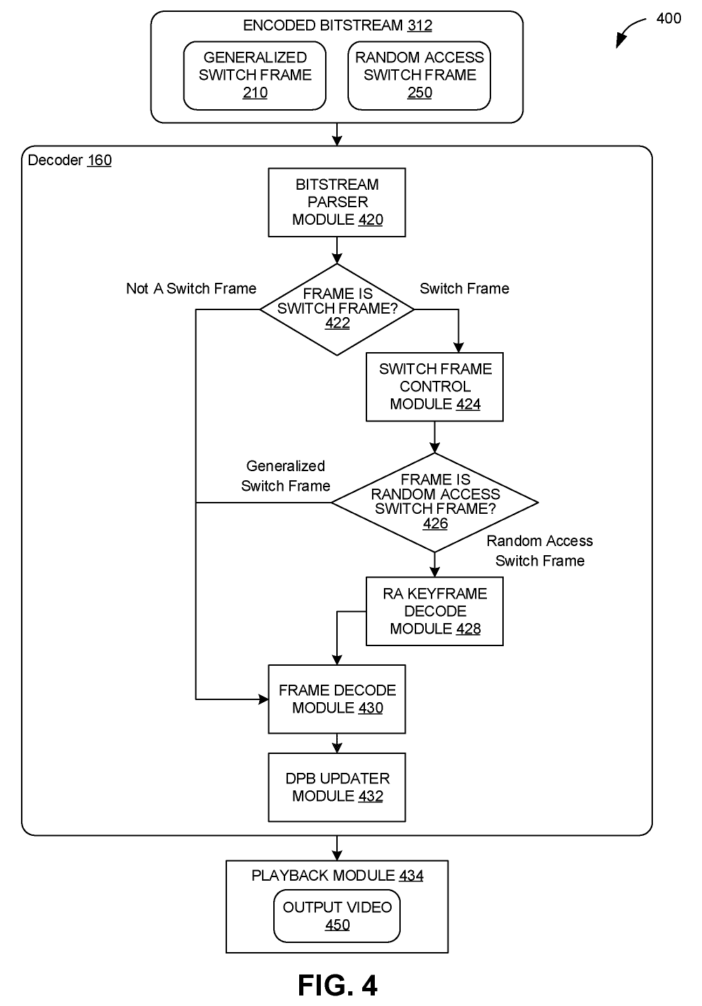

The decoder 160 receives the encoded bitstream through the network 105. Upon receipt, the decoder 160 establishes a decoding session that prepares the internal state of the decoder 160 for parsing frame headers and associated information with each frame in the encoded bitstream, described in further detail below in conjunction with FIG. 4. In some embodiments, the decoder 160 can simultaneously receive multiple segments of the encoded bitstream from different content servers 110 and can reassemble the segments into a continuous sequence.

The decoder 160 parses frame headers and picture payloads, determines whether a current frame is a generalized switch frame or a random access switch frame, and applies switch-specific handling when required. The decoder 160 updates a decoded picture buffer (DPB) using stored references and according to refresh frame flags and related directives. The resulting pipeline ensures that switch frames provide decoder-safe entry points while other frames are decoded with default reference rules.

The decoder 160 then generates reconstructed pictures, described in further detail below in conjunction with FIG. 4, that form output video. The output video represents the decoded sequence of pictures, arranged in display order, and prepared for presentation on the endpoint device 115. The decoder 160 provides the output video to a display subsystem of the endpoint device 115, where each reconstructed picture is rendered. In cases where the encoded bitstream includes audio, the decoder 160 also delivers synchronized audio samples to an audio subsystem of the endpoint device 115.

In some embodiments, the decoder 160 can adapt the delivery of output video by selecting the encode that best suits the hardware and bandwidth capabilities of the endpoint device 115. For example, if the endpoint device 115 includes a high-resolution display and large bandwidth capabilities, then the decoder 160 provides reconstructed pictures at the full resolution available. When the endpoint device 115 includes a lower resolution display, the decoder 160 can provide downscaled reconstructed pictures.

FIG. 2 is a conceptual illustration 200 of various frames and associated fields processed by the encoder 150 and the decoder 160 of the system 100 of FIG. 1, according to various embodiments. As shown, FIG. 2 includes, without limitation, an encoder 150 and a decoder 160. The encoder 150 includes, without limitation, a generalized switch frame 210, a random access switch frame 250, a keyframe 260, an inter frame 270, and an intra-only frame 280. The generalized switch frame 210 includes, without limitation, a frame header 212. The frame header includes, without limitation, a frame type 216, a picture payload 219, and in some embodiments, refresh frame flags 214, a decoder contexts reset 217, and a dependency keyframe reference 252, or frame references 218. The decoder 160 includes a DPB 204.

The DPB 204 includes memory resources within the decoder 160 that store reconstructed pictures after decoding. The reconstructed pictures correspond to previously decoded frames that are restored to a pixel domain representation suitable for prediction and display. The DPB 204 provides such reconstructed pictures as references for inter prediction of subsequent frames. Inter prediction refers to motion-compensated prediction, where blocks of pixels in a current frame are predicted by referencing blocks of pixels from one or more previously reconstructed pictures stored in DPB slots of the DPB 204. In some embodiments, the referenced blocks are identified using motion vectors and indexing information, allowing the decoder 160 to reuse frames that have already been decoded rather than coding new information for each frame.

The DPB 204 is organized into the DPB slots. Each of the DPB slots stores one of the reconstructed pictures and an associated reference state. The reference state includes indexing information that links the DPB slot to a specific frame within the frame references 218 (for the generalized switch frames 210) or the dependency keyframe reference (for the random access switch frames 250), metadata about whether the DPB slot is active or refreshed, and information about resolution and scaling parameters.

In some embodiments, the reconstructed picture in the DPB slot corresponds to a single frame of a specific frame type, such as the keyframe 260, the inter frame 270, the intra-only frame 280, the generalized switch frame 210, or the random access switch frame 250. During reconstruction, certain frame types, such as the inter frame 270 or the generalized switch frame 210, can combine blocks from one or more earlier reconstructed pictures stored in other DPB slots, along with residual data, to form the new frame with a frame type of the inter frame 270, the generalized switch frame 210, or the random access switch frame 250. Once decoding is complete, the result is stored as the reconstructed picture within one of the DPB slots. At any given moment, the DPB 204 can therefore include a mix of reconstructed pictures of different frame types, depending on how the encoder 150 has applied refresh frame flags 214 and the frame references 218.

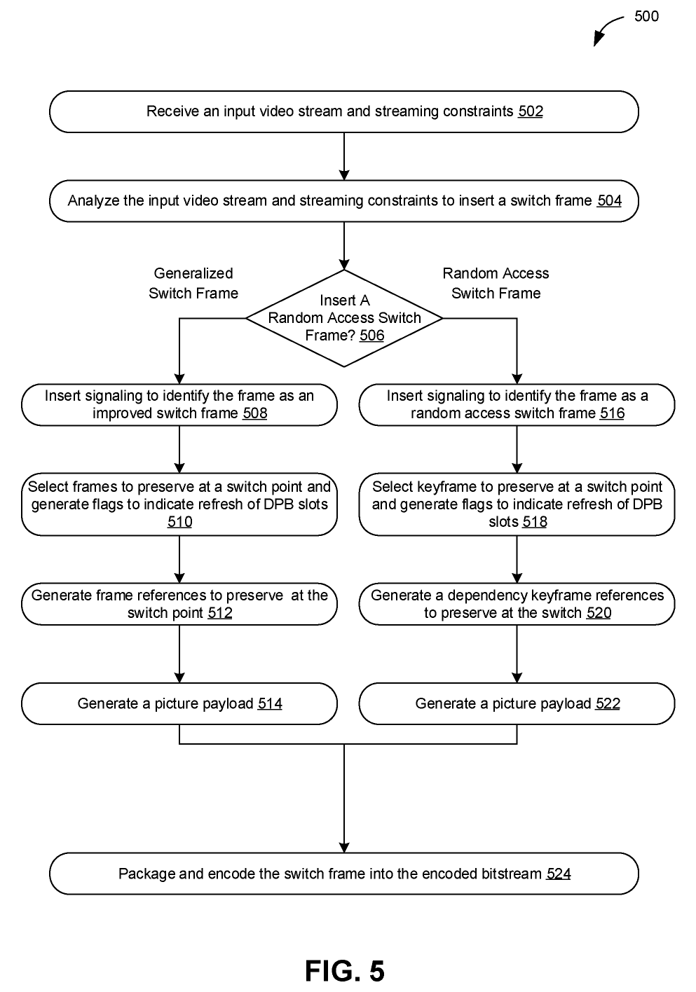

The DPB 204 persists across frame boundaries subject to refresh control. The frame boundary refers to the end of decoding one frame and the beginning of decoding the next frame. The refresh frame flags 214 carried in the frame header 212 instruct the decoder 160 which of the DPB slots to refresh with the current frame and which of the DPB slots to preserve for use as references in subsequent frames. Through this structure, the DPB 204 can enable the encoder 150 to designate long-term frame references that survive beyond the given frame boundary while discarding less useful references. Operation of the DPB 204, including interaction with the refresh frame flags 214, is described in greater detail in conjunction with FIGS. 4-5.

The generalized switch frame 210 establishes a switch point within a bitstream. The switch point allows the decoder 160 to transition between encodes in a bitrate ladder or resolution ladder without relying on the insertion of the keyframes 260 at locations where switching is allowed to occur. By using fewer keyframes 260 and more generalized switch frames 210, the encoder 150 reduces overall bitrate consumption while enabling transitions between different encodes at the switch points.

In conventional AV1 coding, conventional switch frames (S-frames) operate in a rigid manner. The conventional S-frame is an inter-predicted frame that implies the refresh frame flags 214 are set to a fixed value of 0xFF. This setting forces the decoder 160 to refresh every DPB slot of the DPB 204 at the completion of the S-frame. Consequently, all prior references are discarded, and random access is not supported.

The generalized switch frame 210 requires explicit signaling by the refresh frame flags 214 in the frame header 212. Explicit signaling allows the encoder 150 to identify which DPB slots of the DPB 204 should be refreshed and which DPB slots should be preserved at the switch point. In this manner, the generalized switch frame 210 enables selective persistence of the frames within the DPB slots across the frame boundary of the generalized switch frame 210 rather than enforcing a complete refresh of all of the DPB slots. Explicit signaling of the frame references 218 is important for cross-encode determinism. Cross-encode determinism refers to the property that when switching between encodes at the same position in a bitrate ladder, the DPB slots referenced by the decoder 160 correspond to equivalent reconstructed pictures. Without explicit signaling, reference selection could vary between encodes, causing mismatches or drift when switching.

The generalized switch frame 210, when included in the bitstream, signals an implicit switch point through the frame type 216 set as the generalized switch frame 210 type. The frame type 216 identifies the frame as the generalized switch frame 210 and therefore marks the frame as an alignment point across multiple encodes in the bitrate ladder.

The frame header 212 is a data structure included in various types of frames, including the generalized switch frame 210, the random access switch frame 250, the keyframe 260, the inter frame 270, and the intra-only frame 280. The frame header 212 includes fields that define the type and behavior of the given frame.

The frame header 212, in the case of the generalized switch frame 210 and the random access switch frame 250, includes the refresh frame flags 214 and the decoder contexts reset 217. In some embodiments, the frame header 212 also includes fields specific to the random access switch frame 250. In particular, the dependency keyframe reference 252 and a cross-bitstream reference signaling enable the dependency keyframe 260 to originate from another encode within the bitrate ladder. Resolution information is also included for the random access switch frame 250, allowing the decoder 160 to prepare upscaling or downscaling when the referenced keyframe 260 differs in resolution.

The frame header 212 can also include, in some embodiments, a drift tolerance field. For example, the drift tolerance indicates the encoder 150 policy for acceptable visual drift after the switch point. This information is applicable to both the generalized switch frames 210 and the random access switch frames 250 since drift arises when switching between encodes. In some embodiments, the frame header 212 also includes explicit reference ordering, such as disabling short reference signaling to enforce explicit DPB ordering. Explicit reference ordering ensures that equivalent DPB slots correspond to the same references across encodes, which enables cross-encode determinism. Short reference signaling is a shorthand mechanism that signals references using relative indices rather than explicit slot identities. By disabling short reference signaling, the encoder 150 instead ensures that the same DPB slots are interpreted by each decoder. This guarantees cross-encode determinism, meaning that equivalent frames in different bitrate or resolution encodes rely on the same versions of the frame references 218 in the same order.

Drift refers to a gradual divergence between the sequence of reconstructed pictures generated by the decoder 160 after a switch of encodes and the sequence of the reconstructed pictures that would have been generated if the stream had continued without switching. Drift occurs when prediction uses reference pictures that are not bit-for-bit identical across encodes, such as when the generalized switch frame 210 or the random access switch frame 250 references the keyframe 260 or the inter frame 270 encoded at a different bitrate or resolution. The drift accumulates over time and causes visual differences relative to a non-switched path. The drift tolerance defines the level of divergence considered acceptable. A drift threshold specifies a maximum allowable deviation, beyond which the encode policy or the service policy may define an insertion of the keyframe 260 or a full refresh of the DPB 204. Quantifying drift involves measuring differences between reconstructed sequences, often in terms of objective metrics such as peak signal-to-noise ratio (PSNR) or structural similarity index (SSIM).

The refresh frame flags 214 directly reference the DPB slots of the DPB 204 and determine whether the content of each of the DPB slots is preserved or refreshed when decoding the current frame. By explicitly controlling which DPB slots persist across the frame boundary (e.g., switch point), the refresh frame flags 214 give the encoder 150 the ability to maintain long-term frame references while discarding other pictures that are no longer useful for prediction. The refresh frame flags 214 are set by the encoder 150 and are described in further detail below in conjunction with FIG. 3.

In some embodiments, when the refresh frame flags 214 are set to a value, for example, of 0xFF, every DPB slot of the DPB 204 is refreshed with the current frame. This setting reproduces a legacy AV1 S-frame behavior, where decoding the generalized switch frame 210 causes all DPB slots to be replaced, and no frame references are carried forward.

The refresh frame flags 214 also define DPB persistence for the random access switch frame 250. In this case, the refresh frame flags 214 ensure that the DPB slot containing the dependency keyframe 252 is preserved across the random access switch frame 250 boundary. By maintaining the dependency keyframe 260 in place (indicated in the frame header 212 information of the random access switch frame 250 as the dependency keyframe 252), the decoder 160 can safely begin decoding at the random access switch frame 250 without requiring earlier pictures. At the same time, the refresh frame flags 214 allow other DPB slots to be refreshed.

The frame type 216 identifies the type of the current frame. For example, the frame type 216 indicates the generalized switch frame 210, the random access switch frame 250, the keyframe 260, the inter frame 270, or the intra-only frame 280.

The frame type 216 also acts as an implicit marker for switching and random access. In the case of the generalized switch frame 210, the frame type 216 implicitly designates the frame as a switch point. Similarly, in the case of the random access switch frame 250, the frame type 216 implicitly designates the frame as a random access point.

The picture payload 219 refers to compressed picture data associated with the given frame. In some embodiments, the picture payload 219 does not contain raw pixel values but instead contains coded symbols that the decoder 160 interprets to reconstruct a picture. Pixel data is generated after the decoder 160 processes the picture payload 219 through entropy decoding, prediction, and filtering. The encoder 150 generates the picture payload 219 during encoding by transforming and compressing the source video sequence contained in an input stream.

In some embodiments, the picture payload 219 can include tile data. Tile data refers to partitioned regions of the frame that are packaged separately for parsing and parallel decoding. Tile data contains a block-level syntax scoped to a region of a picture, such as prediction modes and residual coefficients for blocks contained within the tile.

In some embodiments, the picture payload 219 further includes information that guides inter prediction. Such information includes motion vectors that describe the displacement of coded blocks relative to the frame references 218 stored in DPB slots of the DPB 204. The information also includes reference indices that map each motion vector to the DPB slot to be used.

In some embodiments, the picture payload 219 also includes intra prediction modes and inter prediction modes. Intra prediction modes describe how the blocks are predicted from neighboring pixels located within the same frame, without reference to external frames. Inter prediction modes describe how a block is predicted from reconstructed pictures already stored in DPB slots, using the motion vectors and reference indices included in the picture payload 219. Together, the intra prediction modes and inter prediction modes provide the decoder 160 with the instructions needed to reconstruct picture content.

In some embodiments, the picture payload 219 includes transform and residual symbols. The transform and residual symbols are quantized transform coefficients that represent the residual, or difference, between the predicted block and the original block from the source sequence. An associated syntax includes signaling for inverse transformations, dequantization steps, and residual reconstruction, which the decoder 160 applies to refine the prediction into a more accurate representation of the original frame content.

In some embodiments, the picture payload 219 includes quantization parameters. The quantization parameters define the quantization step sizes used by the encoder 150 when compressing the transform coefficients. The quantization parameters are essential for the decoder 160 to correctly scale and interpret residual values during reconstruction.

In some embodiments, the picture payload 219 also includes loop filter and restoration control data. The loop filter and restoration control data include syntax that directs in-loop deblocking filters, loop restoration filters, and film grain synthesis (when applicable). Such processes improve visual quality by reducing block artifacts, restoring edge detail, or synthesizing grain patterns that approximate the texture of the source. Such information is generated by the encoder 150 based on analysis of the input stream and the encode policy.

In some embodiments, the picture payload 219 can include metadata that supports correct reconstruction and display. Such metadata specifies color space identifiers, subsampling formats, frame resolution data, and other descriptive fields required for display systems to present the reconstructed frame accurately. The metadata and other sub-components of the picture payload 219 are generated by the encoder 150 based on the properties of the input stream, the service policy, and the encode policy, discussed in greater detail in conjunction with FIG. 3.

The decoder contexts reset 217 is a field in the frame header 212 that directs the decoder 160 to reset the decoding contexts. The decoding contexts refer to information that accumulates across frames during the decoding process. Examples include entropy coding states, which maintain evolving probability distributions of symbols, and adaptive state models, which capture statistical dependencies such as motion vectors, transform coefficients, or prediction modes. Such decoding contexts influence how subsequent frames are interpreted, but are distinct from the DPB 204, so that persistence of the DPB slots is separately governed by the refresh frame flags 214. The decoder contexts reset 217 ensures determinism when switching between encodes or when beginning playback from the random access point. Determinism in this case guarantees that, regardless of the playback history or the encode chosen at a switch point, the decoder 160 will reconstruct identical output from the same bitstream input. By resetting the decoder context, the decoder 160 begins with a defined baseline that avoids drift or desynchronization between encodes.

The decoder contexts reset 217 also instructs the decoder 160 to reset probability models used for adaptive entropy coding. These probability models track symbol frequency estimates that evolve as frames are decoded. Symbol statistics represent the likelihoods of coding elements, such as prediction modes or residual values, that allow entropy coders to compress data more efficiently as patterns repeat. Resetting these models restores symbol statistics to predefined defaults, ensuring that the decoder 160 interprets entropy-coded symbols in the same way every time a transition or entry occurs.

The decoder contexts reset 217 is used by the generalized switch frame 210, the random access switch frame 250, and the keyframe 260. Each of these frame types marks a potential transition or entry point in the bitstream. For the generalized switch frame 210, the decoder contexts reset 217 ensures that all adaptive states are cleared while selected DPB slots can persist. For the random access switch frame 250, the decoder contexts reset 217 guarantees a safe entry point by clearing adaptive states while preserving only the dependency keyframe 260. For the keyframe 260, the decoder contexts reset 217 is set because the keyframe 260 represents a full reset that discards all prior decoding contexts as well as all the DPB slots, establishing a clean baseline for continued decoding.

The frame references 218 is a field included in the frame header 212 of the generalized switch frame 210 and specifies which DPB slots of the DPB 204 are used for inter prediction of the current frame. Entries in the frames references 218 point to the DPB slots that contain reference frames, thereby instructing the decoder 160 which reconstructed pictures (e.g., reference frames) to use as sources for inter prediction.

The frame references 218, in the case of a generalized switch frame 210, identify the DPB slots that correspond to different types of reconstructed pictures. For example, the encoder 150 can configure the frame references 218 to point to one or more of the inter frames 270 or one or more of the intra-only frames 280 that are preserved in the DPB 204.

The frame references 218, in the case of the random access switch frame 250, are known specifically as the dependency keyframe reference 252. The decoder 160 uses one of the DPB slots to perform inter prediction of the random access switch frame 250. In the case of the random access switch frame 250, including the frame references 218 as the keyframe 260 ensures that decoding can safely begin at the random access switch frame 250.

The random access switch frame 250 is a specialized type of the generalized switch frame 210 designed to establish a decoder-safe entry point, known as random access, into the bitstream. The random access switch frame 250 can depend on the keyframe 260.

The random access switch frame 250 is identifiable in the bitstream by the frame type 216. If the frame type 216 signals that the frame is the random access switch frame 250, then the decoder 160 recognizes the frame as a valid random access point. In some embodiments, although this implicit identification is sufficient for operation, the frame header 212 can also include a random access marker, which can provide an explicit signal, enabling content distribution systems to locate valid random access points via the random access marker.

The persistence of the dependency keyframe reference 252 across the random access switch frame 250 is controlled by the refresh frame flags 214. For this frame type, the refresh frame flags 214 are configured so that the DPB slot containing the designated keyframe 260 is preserved, while the other DPB slots of the DPB 204 are refreshed.

The random access switch frame 250 also includes the dependency keyframe reference 252 in the frame header 212. In some embodiments, the dependency keyframe reference 252 is a non-shown reference stored in a DPB slot or originates from another encode when cross-bitstream references are permitted. Prediction of the random access switch frame 250 is performed through inter prediction from the designated keyframe 260.

The keyframe 260 is a type of intra-only frame 280 that is coded with intra prediction. Intra prediction refers to prediction within the current frame, using already decoded blocks of the given frame, rather than referencing prior reconstructed pictures from the DPB 204. As a result, the keyframe 260 does not rely on any DPB slot for inter prediction. In AV1, the keyframe 260 also establishes decoder state consistent with a random access point. This reset of decoder state ensures that the decoder 160 can begin decoding reliably at the keyframe 260 without depending on prior context.

The keyframe 260 can serve two distinct roles. (1) The keyframe 260 is shown directly for display to the user, providing a visible picture in the playback sequence, and (2) the keyframe 260 is preserved as a reference stored in the DPB slot of the DPB 204, either shown or non-shown. Whether shown or non-shown, the keyframe 260 supplies prediction to other frame types, including the random access switch frame 250.

In some embodiments, the bandwidth cost of the keyframe 260 is higher than that of other frame types because every block in the frame is intra-coded without the reuse of previously reconstructed content, which makes frequent insertion of the keyframes 260 inefficient for adaptive streaming.

The inter frame 270 is a frame type that relies on temporal references to reconstruct content of the inter frame 270. Temporal references refer to reconstructed pictures stored in DPB slots of the DPB 204 that originate from earlier frames in decoding order. In some embodiments, the encoder 150 signals motion vectors and reference indices that instruct the decoder 160 how to copy blocks of pixels from previously reconstructed pictures. By combining the referenced blocks with residual data, the inter frame 270 achieves compression efficiency by reusing earlier content rather than coding the frame entirely via intra prediction.

The intra-only frame 280 is a frame type that uses only intra prediction within the current frame. Because no inter prediction is performed, the intra-only frame 280 avoids dependency on the DPB 204. Unlike the keyframe 260, however, the intra-only frame 280 generally does not include the decoder contexts reset 217. Such a distinction allows the intra-only frame 280 to refresh picture quality without requiring all of the decoder 160 contexts to be reinitialized.

In some embodiments, the intra-only frame 280 is positioned between the generalized switch frames 210 to restore visual fidelity while maintaining lower overhead than inserting frequent keyframes 260. By coding the entire frame intra, the intra-only frame 280 prevents error accumulation from extended sequences of inter frames 270 or the generalized switch frames 210. At the same time, the intra-only frame 280 consumes fewer bits than the keyframe 260 because the intra-only frame 280 avoids the decoder contexts reset 217 and signaling overhead associated with the keyframe 260.

FIG. 3 is a more detailed illustration of the encoder 160 for generation of the generalized switch frames 210 and the random access switch frames 250 of FIG. 2, according to various embodiments. FIG. 3 includes, without limitation, an input stream 310, an encoder 150, and an encoded bitstream 312. The encoder 150 includes, without limitation, a switch point selector module 320, a flag module 322, a frame reference module 324, a payload generator module 325, and a bitstream writer module 326.

The input stream 310 is a data structure that includes a source video sequence and associated timing metadata. The source video sequence represents uncompressed pictures arranged in decoding order that are fed into the encoder 150 for encoding. The timing metadata refers to information that specifies when each picture in the sequence should be decoded and presented. Examples of timing metadata include frame timestamps, presentation timestamps (PTS), and decode timestamps (DTS). Such signals ensure that the reconstructed pictures are shown in the correct temporal order and allow the encoder 150 to align frame boundaries with designated switch points, random access points, or other structural events in the encoded bitstream 312.

The encoder 150 receives the input stream 310, an encode policy, a service policy, and picture metrics. The encode policy specifies the set of encodes generated for adaptive streaming, including the supported bitrates and resolutions. The picture metrics refer to structural and perceptual measures computed from the input stream 310, such as scene change indicators, motion intensity levels, coding complexity, or temporal distance from earlier switch points. Such picture metrics enable the encoder 150 to place switch points at locations where perceptual impact and coding cost are minimized. The service policy refers to operational rules defined by a streaming service, such as maximum allowable startup delay, acceptable quality drift thresholds, or preferred switching frequency.

The encoder 150 delegates operation to relevant modules. The switch point selector module 320 determines where a switch point or random access point should occur. The flag module 322 defines persistence of frames in a DPB 204 and indicates when decoder contexts should be reset. The frame reference module 324 selects the references 218, generates a dependency keyframe reference 252, and enforces cross-encode determinism. The payload generator module 325 generates the picture payload 219. The bitstream writer module 326 assembles the frame header 212 and serializes the encoded picture data into the encoded bitstream 312. The payload generator module 325 generates the picture payload 219. The encoder 150 then outputs the encoded bitstream 312. The encoded bitstream 312 includes the generalized switch frames 210 at designated locations and the random access switch frames 250 at designated locations. It is noted that although the DPB 204 is included in a decoder 160, the encoder 150 includes a local conceptual mirror copy to support encoding.

The switch point selector module 320 receives the picture metrics from the input stream 310, the current state of the DPB 204, the encode policy, and the service policy. In the case of generating a generalized switch frame 210, the switch point selector module 320 identifies a switch point where selective DPB persistence and inter prediction can provide efficiency gains. At the switch point, based on the picture metrics, the DPB 204 state, the encode policy, and the service policy, the switch point selector module 320 sets frame type 216 equal to the generalized switch frame 210.

In the case of generating the random access switch frame 250, the switch point selector module 320 identifies a random access point. The switch point selector module 320 sets the frame type 216 equal to the random access switch frame 250 when the picture metrics and the DPB 204 state indicate that a clean entry point can be established with reliance on the keyframe 260.

In both cases, the decision of frame type 216 reflects an analysis of the input stream 310, the DPB 204, the encode policy, the service policy, and the picture metrics. The switch point selector module 320 outputs the frame type 216 to subsequent modules.

In some embodiments, the switch point selector module 320 pre-computes a persistence plan based on the picture metrics, the current state of the DPB 204, the encode policy, and the service policy. The persistence plan refers to the slot-by-slot mapping that defines which DPB slots should persist and which refresh across the frame boundary. The persistence plan defines, for each DPB slot, whether the reconstructed picture in the given DPB slot will persist across the boundary and which of the frame references 218 are held in slots that persist or will be refreshed.

The flag module 322 then receives the current state of the DPB 204 and, when applicable, random access dependency instructions. The random access dependency instructions specify whether the random access switch frame 250 must preserve a DPB slot that contains a designated keyframe 260. By combining such information with the DPB 204 state, the flag module 322 determines how buffer persistence should be controlled at the boundary of the current frame.

The flag module 322 computes the refresh frame flags 214, where the selection of the refresh frame flags 214 depends on the frame type 216. For the generalized switch frame 210, the refresh frame flags 214 preserve the DPB slots identified as valuable for continued prediction while refreshing others. For the random access switch frame 250, the refresh frame flags 214 preserve the DPB slot containing the dependency keyframe 252 to be added and refresh the remainder of the DPB slots.

In both cases, selecting the refresh frame flags 214 can depend on the encode policy, the service policy, and/or the picture metrics. In some embodiments, the flag module 322 selects the refresh frame flags 214 based on the persistence plan as well. For example, the encode policy may require fewer preserved references to maintain bitrate efficiency, while a higher tier encode policy may instead allow retention of additional long-term references to maximize visual stability. The service policy may force periodic full refresh to align with delivery schedules to prevent drift from accumulating during extended playback or to ensure that advertisements and inserted content begin from a clean buffer state. The picture metrics, such as detected scene cuts, may influence which reference pictures in DPB slots are preserved. For instance, a sharp scene cut may cause all earlier references to be refreshed, whereas a gradual scene transition may allow one or two reference pictures to persist to smooth quality across the transition. In some embodiments, the flag module 322 enables the setting of the refresh frame flags 214 to, for example, a mask value of 0xFF, which will force every DPB slot to refresh, aligning the bitstream with pre-existing AV1 functionality.

The flag module 322 also attaches the decoder contexts reset 217 to the frame header 212 when the current frame requires a reset of adaptive coding states. The decoder context reset 217 provides a clear signal to the decoder 160 that state flushing is mandatory. The outputs of the flag module 322 include the refresh frame flags 214 and the decoder contexts reset 217.

The frame reference module 324 receives the refresh frame flags 214, the decoder contexts reset 217, the encode policy, the service policy, the picture metrics, and the current contents of the DPB slots. Such inputs define both the constraints and the opportunities for selecting the frame references 218.

The frame reference module 324 generates the frame references 218 that specifies the DPB slots to be used for inter prediction of the current frame (e.g., the generalized switch frames 210 or the random access switch frame 250 for both cases). In some embodiments, the frame reference module 324 aligns across different encodes by disabling short reference signaling when necessary.

For the generalized switch frame 210 case, the frame reference module 324 selects the frame references 218. In some embodiments, the frame reference module 324 selects the frame references based on the persistence plan. The frame reference module 324 then aligns the selected frame references 218 across different encodes so that DPB slots map to equivalent reconstructed pictures at the switch point. Such alignment ensures that switching between encodes minimizes mismatches and drift.

For the random access switch frame 250 case, the frame reference module 324 identifies and selects the dependency keyframe reference 252. In some embodiments, when the dependency keyframe 260 originates from another encode, the frame reference module 324 prepares cross-bitstream reference signaling. Cross-bitstream signaling directs the decoder 106 to interpret the dependency keyframe reference 252 as valid even though the dependency keyframe reference 252 comes from a different encode. The frame reference module 324 also attaches resolution metadata when the dependency keyframe 260 has a different resolution than the current frame, enabling the decoder 160 to apply upscaling or downscaling during prediction.

The frame reference module 324 also verifies in the random access switch frame 250 case that the selected dependency keyframe reference 252 is available in the DPB 204 and aligned for use. The frame reference module 324 also checks that the refresh frame flags 214 preserve the DPB slot storing the dependency keyframe reference 252. If the dependency keyframe reference 252 is not already available, the frame reference module 324 can schedule prefetch to ensure that such dependency keyframe reference 252 is loaded. Verification results are tracked to confirm that the signaling is consistent and decoder safe.

The payload generator module 325 generates the picture payload 219. Based on decisions by upstream modules, the payload generator module 325 generates the input stream 310 picture content into the picture payload 219. The payload generator module 325 also utilizes the reference frames 218 for inter prediction. Although the DPB 204 is pictured on the decoder 160 side, the encoder 150 maintains a conceptual mirror of expected DPB slots to track which reconstructed frames are available for prediction. The encoder 150 conceptual mirror does not perform playback but instead reconstructs frames as the decoder 160 would, allowing the encoder 150 to simulate inter prediction when deciding how to encode new frames. The encoder 150 tracking enables the payload generator module 325 to utilize the reference indices that will later be used by the decoder 160, ensuring consistency between the encoder 150 and the decoder 160. In addition, the payload generator module 325 uses quantization parameters, prediction decisions, and filtering directives derived from the encode policy, the service policy, and the picture metrics to guide how data is compressed, which references are preferred, and what level of filtering or enhancement is applied.

In some embodiments, the payload generator module 325 partitions the given frame into tiles to enable parallel coding. In some embodiments, the payload generator module 325 performs block-level prediction, where intra prediction uses neighboring pixels within the same frame and inter prediction uses DPB slot references indicated by the frame references 218. The payload generator module 325 then calculates residuals by subtracting the prediction from the actual source block, applies transforms to the residuals, and quantizes the coefficients according to the selected quantization parameters. The payload generator module 325 then entropy codes symbols, including motion vectors, prediction modes, coefficients, and auxiliary maps. The payload generator module 325 further generates loop filter control data and restoration syntax to guide the decoder 160 in reconstructing the frame with reduced artifacts. Finally, the payload generator module 325 inserts metadata such as color space identifiers, resolution, and subsampling format, based on the input stream 310 and the policy requirements.

The generated result of the payload generator module 325 is the picture payload 219. The payload generator module 325 outputs the picture payload 219 to the bitstream writer module 326.

The bitstream writer module 326 receives the frame type 216, the refresh frame flags 214, the decoder contexts reset 217, the picture payload 219, and the frame references 218 or the dependency keyframe reference 252.

The bitstream writer module 326 assembles the frame header 212 with the fields from the upstream modules. In the case of a generalized switch frame 210, the bitstream writer module 326 writes the frame header 212 with the refresh frame flags 214 and the frame references 218. The bitstream writer module 326 then serializes the picture payload 219 of the current frame, where the frame has been encoded using inter prediction from the selected DPB slots specified in the frame references 218.

In the case of the random access switch frame 250, the bitstream writer module 326 writes the frame header 212 with the refresh frame flags 214 and the dependency keyframe reference 252. The bitstream writer module 326 then serializes the picture payload 219 of the current frame, where the frame has been encoded using inter prediction from the dependency keyframe reference 252.

The bitstream writer module 326 also emits the required syntax structures according to the adopted signaling convention. In some embodiments, the frame header 212 is wrapped into an open bitstream unit (OBU) of a defined type, such as OBU_SWITCH_FRAME for a generalized switch frame 210 or OBU_RAS_FRAME for a random access switch frame 250. In other embodiments, the required syntax uses data structures such as frame_type identifiers embedded in the frame header 212. Both approaches preserve compliance with syntax for the encoded bitstream 312. The resulting frame is appended to the encoded bitstream 312, which serves as the final output object for distribution.

The encoded bitstream 312 includes a sequence of frames generated by the bitstream writer module 326. The encoded bitstream 312 contains the generalized switch frames 210 and the random access switch frames 250 at selected switch and random access points. Such frames are interleaved with other frame types, such as the keyframes 260, the inter frames 270, and the intra-only frames 280, which are generated by respective processes within the encoder 150.

The encoded bitstream 312 is formatted as a continuous sequence of compliant frames. In some embodiments, the encoded bitstream 312 uses either OBU-based signaling or a frame_type-based signaling, depending on the implementation approach. In the OBU-based embodiment, distinct OBU types are reserved for the generalized switch frame 210 and the random access switch frames 250, enabling faster identification of switch points. In the frame_type-based embodiment, the signaling occurs through the frame header 212, reducing the number of OBU types required. Both approaches are compatible with existing decoder 160 workflows. The encoded bitstream 312 is transmitted to the decoder 160 using delivery techniques such as through a content distribution network or via direct streaming.

FIG. 4 is a more detailed illustration of the decoder 160 for decoding the generalized switch frames 210 and the random access switch frames 250 of FIG. 2, according to various embodiments. FIG. 4 includes, without limitation, an encoded bitstream 312, a decoder 160, and an output video 450. The decoder 160 includes, without limitation, a bitstream parser module 420, a switch frame check 422, a switch frame control module 424, a random access switch frame check 426, an RA keyframe decode module 428, a frame decode module 430, and a DPB updater module 432.

The bitstream parser module 420 receives a current frame from the encoded bitstream 312. The bitstream parser module 420 extracts the frame header 212 and the picture payload 219 of the current frame to prepare for downstream decoding. The bitstream parser module 420 reads fields of the frame header 212, which include the frame type 216, the refresh frame flags 214, the decoder contexts reset 217, and the frame references 218 or the dependency keyframe reference 252.

The bitstream parser module 420 extracts the picture payload 219, which contains compressed picture data that includes tile data, motion information, prediction modes, transform and residual symbols, quantization parameters, and filtering directives. The tile data refers to partitioned regions of the picture that facilitate parallel parsing and decoding. The motion information and prediction modes describe the methods by which each block is predicted, either by intra prediction from neighboring pixels within the same frame or by inter prediction using reference pictures stored in the DPB 204. The transform and residual symbols represent the coded residual differences between predictions and the original blocks, and the quantization parameters define how the residual symbols were compressed by the encoder 150. The filtering directives specify loop filter and restoration processes to be applied during reconstruction by the decoder 160.

The bitstream parser module 420 outputs the frame type 216, the picture payload 219, the refresh frame flags 214, the decoder contexts reset 217, and the frame references 218 or the dependency keyframe reference 252 to downstream modules.

The switch frame check 422 receives the frame type 216 parsed by the bitstream parser module 420. The switch frame check 422 evaluates whether the current frame type 216 is a switch frame, e.g., the generalized switch frame 210 or the random access switch frame 250.

If the evaluation determines that the current frame is not a switch frame, then the decision module 422 routes the frame directly to the frame decode module 430. In such a case, decoding proceeds with reference usage and DPB update rules as defined by the frame header 212. Such a path applies to keyframes 260, inter frames 270, and intra-only frames 280, which do not require handling specific to switch frames. If the evaluation determines that the current frame is a switch frame, then the decision module 422 routes the frame to the switch frame control module 424.

The switch frame control module 424 receives the refresh frame flags 214, the decoder contexts reset 217, and the frame references 218 or the dependency keyframe reference 252 parsed by the bitstream parser module 420.

The switch frame control module 424 applies the decoder contexts reset 217 to clear entropy coding contexts and adaptive state models. Entropy coding contexts include the probability models used for arithmetic or binary coding, and adaptive state models include motion vector predictors and other adaptation histories. At the same time, the persistence of the DPB 204 slots remains under the control of the refresh frame flags 214, which are later applied in the DPB updater module 432.

The switch frame control module 424 configures references based on the frame references 218. For the generalized switch frame 210, each reference index is mapped to the DPB slot listed in the frame references 218. This mapping ensures that motion-compensated prediction to the set of the frame references 218, which prevents the decoder 160 from accessing non-permitted slots. When scale factors or format differences are present, such as a mismatch in spatial resolution or chroma subsampling between the current frame and the frame references 218, the switch frame control module 424 associates the necessary adjustment parameters. For the random access switch frame 250, the usable set of references is restricted to the DPB slot identified by the dependency keyframe reference 252. If the dependency keyframe 260 has a different resolution or format, scaling and format adjustment parameters are provided along with the restriction.

In some embodiments, the switch frame control module 424 enforces explicit reference ordering. In the generalized switch frame 210 case, the switch frame control module 424 uses the order of the frame references 218 for lookups. In the random access switch frame 250 case, the dependency keyframe reference 252 ensures that only the designated dependency keyframe 252 is used. While ordering is trivial, the ordering is still explicitly signaled to preserve cross-encode alignment.

The random access switch frame check 426 receives the frame type 216 and the dependency keyframe reference 252. The random access switch frame check 426 evaluates whether the frame type 216 indicates a random access switch frame 250. If the evaluation determines that the frame is instead a generalized switch frame 210, the random access switch frame check 426 proceeds to the frame decode module 430. If the evaluation determines that the frame is a random access switch frame 250, the decision module 426 proceeds to the RA keyframe decode module 428.

The RA keyframe decode module 428 receives the dependency keyframes reference 252 and the picture payload 219. The RA keyframe decode module 428 ensures that the dependency keyframe reference 252 is decoded and available in the DPB 204 before the random access switch frame 250 begins decoding. This guarantee is important because the random access switch frame 250 relies on the dependency keyframe 260 for inter prediction. Without confirmation that the reference exists, decoding could fail or cause drift.

Although the DPB 204 is generally updated only after the frame decode module 430 reconstructs the current frame, the RA keyframe decode module 428 performs an earlier check specifically for the dependency keyframe 260. Performing an earlier check specifically for the dependency keyframe 260 does not update the DPB 204 with the current frame but instead verifies that the referenced keyframe 260 is already present in a DPB slot or decodes the referenced keyframe 260 on demand if the referenced keyframe 260 is missing. The actual insertion of the random access switch frame 250 into the DPB 204 occurs later in the DPB updater module 432.

The RA keyframe decode module 428 performs a sequence of operations to ensure that the dependency keyframe reference 252 is available and valid in the DPB 204. First, the RA keyframe decode module 428 conducts a presence check to determine whether the dependency keyframe reference 252 is reconstructed and stored in a DPB slot. If the keyframe 260 is present, the existing DPB slot is reused, avoiding redundant decoding. If the keyframe 260 is not available, the RA keyframe decode module 428 initiates a decode-on-demand process by instructing the frame decode module 430 to decode the dependency keyframe reference 252 from the picture payload 219.

In cases where the dependency keyframe 260 has a different resolution from the current random access switch frame 250, the RA keyframe decode module 428 computes the scale factors necessary to reconcile the resolution difference. Such scale factors are provided to the frame decode module 430 so that prediction using the dependency keyframe reference 252 remains accurate despite mismatched dimensions.

The RA keyframe decode module 428 outputs the verified DPB slot index that stores the dependency keyframe 260, along with any required scaling parameters. Such outputs are passed to the frame decode module 430.

The frame decode module 430 receives the picture payload 219 for the current frame from the bitstream parser module 420, reference usage directives from the switch-frame control module 424, and, in the case of a random access switch frame 250, the DPB slot with the dependency keyframe reference 252. The reference usage directives define which DPB slots from the frame references 218 are authorized for inter prediction. In cases where explicit ordering is required, the frame decode module 430 enforces the sequence specified by the encoder 150.

The frame decode module 430 performs reconstruction through a sequence of coding operations. First, entropy decoding is applied to recover block-level symbols from the compressed syntax. Intra prediction is then used for blocks predicted entirely within the current frame based on neighboring pixels. For blocks that require external references, inter prediction is performed using motion compensation from the DPB slots. In some embodiments, if the resolution of a reference frame differs from the current frame, then the scaling parameters are applied to ensure alignment. Residuals are reconstructed through inverse transforms and dequantization, which correct the difference between prediction and the original coded block. The frame decode module 430 also applies in-loop filtering operations, such as deblocking and restoration filters, to reduce artifacts and improve the visual quality of the reconstructed picture.

The application of references varies by the frame type 216. For the generalized switch frame 210, the frame decode module 430 uses the full set of DPB slots specified in the frame references 218, enforcing the provided ordering to ensure deterministic reference use. For the random access switch frame 250, the frame decode module 430 restricts inter prediction to the single DPB slot that stores the dependency keyframe reference 252 and applies any scaling parameters or format adjustments if the dependency keyframe 260 differs in resolution or format. For non-switch frames, such as the keyframes 260, the inter frames 270, or the intra-only frames 280, the frame decode module 430 follows default reference selection rules as defined by the frame header 212, the encode policy, and the service policy.

The frame decode module 430 precedes the DPB updater module 432 in the decoding pipeline so that the decoder 160 uses the existing DPB 204 contents as valid references during reconstruction. By decoding first, the current frame does not depend on the future state of the current frame, and valid references are not cleared prematurely. Only after frame reconstruction is complete does the DPB updater module 432 apply the refresh frame flags 214 and update the DPB 204.

The frame decode module 430 outputs the reconstructed picture along with any side information, such as reference usage results and scaling details, to the DPB updater module 432.

The DPB updater module 432 receives the reconstructed picture from the frame decode module 430 with the refresh frame flags 214, the frame references 218, or the dependency keyframe 252, in addition to reference usage directives provided by the switch frame control module 424. The DPB updater module 432 applies frame-level persistence rules after picture reconstruction, so the existing DPB 204 references remain valid during decoding and only change after a complete picture becomes available.

For a non-switch frame, the DPB updater module 432 inserts the reconstructed picture into a target DPB slot defined by the encoder policy and/or the service policy and leaves other DPB slots unchanged. The DPB updater module 432 also updates per-slot metadata for the target slot, including a reference availability flag, display status, and any other information required in later frames.

For the generalized switch frame 210, the DPB updater module 432 first reads the refresh frame flags 214 to obtain a slot-by-slot mask. In some embodiments, a set bit indicates that the DPB slot persists across the switch boundary while a clear bit indicates that the DPB slot is to be refreshed. If the value equals 0xFF, then the DPB updater module 432 performs a full refresh that clears every DPB slot.

In some embodiments, after reading the refresh frame flags 214 for the generalized switch frame 210, the DPB updater module 432 retains the DPB slots marked to persist and refreshes the remaining DPB slots by invalidating reference availability flags and dropping associated metadata.

If explicit reference ordering is signaled for the generalized switch frame 210, then the DPB updater module 432 rewrites DPB slot indices to match the order specified by the frame references 218. The reordering step does not move pixel data in memory. The reordering step updates index mapping, so a given reference index resolves to the same reconstructed picture across encodes.

The DPB updater module 432 then inserts the reconstructed generalized switch frame 210 into the target DPB slot and marks the picture as a reference for later inter prediction. In some embodiments, the DPB updater module 432 records frame type and timestamp in per-slot metadata to support downstream decisions.

For the random access switch frame 250, the DPB updater module 432 confirms the presence of the dependency keyframe 260 identified by the frame header 212. The DPB updater module 432 checks the DPB 204 for a valid slot that matches the dependency keyframe reference 252 and the expected timestamp.

The DPB updater module 432 retains the DPB slot that stores the dependency keyframe 260 and clears other DPB slots according to the refresh frame flags 214. If explicit ordering is signaled for the random access switch frame 250, then the DPB updater module 432 applies ordering with the dependency keyframe 260 in the canonical position included in the dependency keyframe reference 252.

The DPB updater module 432 then inserts the reconstructed random access switch frame 250 into the target DPB slot and marks the picture as a reference. The DPB updater module 432 also marks a random access point in the output video 450. The entry-point mark supports decoder 160 startup or mid-stream join and thereby marks a safe point where the dependency keyframe 260 and the random access switch frame 250 are present together.

The DPB updater module 432 maintains slot index mapping, reference availability flags, per-slot attributes such as resolution and color format, and any persistence counters that guide eviction on future updates. The DPB updater module 432 outputs the updated DPB 204 state and the reconstructed picture to the next decode cycle and to the output video 450.

### Video Playback

The playback module 434 receives the reconstructed picture and the updated DPB 204 from the DPB updater module 432. The playback module 434 generates the output video 450 by scheduling, formatting, and presenting reconstructed pictures.

In some embodiments, the playback module 434 applies timing based on timing metadata carried through the bitstream 350. Such timing metadata includes a decode timestamp and a presentation timestamp for the current frame. In some embodiments, the playback module 434 forms a presentation queue using the presentation timestamp so that display cadence matches the intended frame rate and aligns with companion audio streams. If decode order differs from display order, then the playback module 434 reorders reconstructed pictures in the presentation queue before generating the output video 450.

If the DPB updater module 432 marks a random access point, then the playback module 434 begins presentation at the random access switch frame 250 and does not display a non-shown dependency keyframe 260. When a generalized switch frame 210 completes a switch between encodes, the playback module 434 presents the reconstructed picture.

The playback module 434 performs display-domain formatting based on fields in the frame header 212 and in the picture payload 219. Such formatting can include color space conversion, chroma resampling, and spatial scaling to a display resolution of an endpoint device 115.

The playback module 434 applies the service policy to govern presentation behavior. The service policy can specify latency targets, audio-video synchronization tolerance, or playback rate adjustments. Based on the service policy, the playback module 434 selects buffer sizes for the presentation queue, chooses frame-drop or frame-repeat strategies, and coordinates start times for startup and mid-stream join at a marked random access point.

The playback module 434 generates the output video 450 by delivering scheduled and formatted pictures to a display subsystem of the endpoint device 115 or to a downstream capture interface. The output video 450 therefore reflects the switch decisions and random access points described by the frame header 212 while maintaining a stable and deterministic presentation sequence.

In operation, to switch between encodes using a generalized switch frame 210, the playback module 434 detects a switch request based on the service policy or an adaptive bitrate control decision. The playback module 434 locates the generalized switch frame 210 by inspecting frame type 216 within the frame header 212. The playback module 434 trims the presentation queue by discarding reconstructed pictures scheduled for display before the presentation timestamp of the generalized switch frame 210, thereby ensuring that output video 450 begins with the reconstructed picture of the generalized switch frame 210 and that the display cadence remains aligned with the intended presentation order. The display cadence refers to the pacing at which reconstructed pictures are presented to the user on the display of the endpoint device 115. The display cadence is derived from presentation timestamps carried in timing metadata, which define the exact interval between successive pictures (e.g., 33 milliseconds for 30 frames per second).

The playback module 434 then begins scheduling the reconstructed picture associated with the generalized switch frame 210 into output video 450 according to the presentation timestamps. In some embodiments, pre-switch pictures that violate display order are discarded from the presentation queue to prevent out-of-order display artifacts. In some embodiments, the playback module 434 applies display-domain formatting based on fields carried in the frame header 212 and metadata in the picture payload 219. Display-domain formatting refers to operations performed solely for presentation, including color space conversion, chroma resampling, and spatial scaling to a display resolution of an endpoint device 115. If the switch involves a resolution change, then the playback module 434 applies spatial scaling so that picture geometry remains correct on the display surface.

The playback module 434 maintains audio-video synchronization by aligning presentation timestamps to an audio clock, in some embodiments. If buffer conditions cause a brief overflow, then the playback module 434 applies a frame-drop or frame-repeat policy specified by the service policy so that display timing and alignment with related signals, such as audio streams, remain within the service policy tolerance.

The playback module 434 then continues presentation of post-switch pictures in display order while accepting drift that can result from the switch event. The drift tolerance defined by the encode policy provides limits for acceptable visual divergence experienced by switching viewers while preserving bitrate efficiency for non-switching viewers.

The playback module 434 records the switch event for monitoring and exposes the switch position for diagnostics or manifest updates. In cases where the random access switch frame 250 is also used to perform an encode switch, the playback module 434 follows the same scheduling and display-domain formatting steps while using the dependency keyframe 260 anchor to minimize visible artifacts during the transition.

In operation, for a random access startup or mid-stream join using the random access switch frame 250, the playback module 434 detects a random access request due to a seek, a live join, or a service policy directive. The playback module 434 locates the random access switch frame 250 by inspecting frame type 216 within the frame header 212. The playback module 434 confirms that upstream modules have made the dependency keyframe 260 available by way of the dependency keyframes reference 252 and that decoder context reset 217 and refresh frame flags 214 establish a clean entry state.

The playback module 434 clears any pre-entry pictures from the presentation queue and rebases scheduling to the presentation timestamp of the random access switch frame 250. The playback module 434 presents the random access switch frame 250 in output video 450 and does not present a non-shown dependency keyframe 260 that persists in the DPB 204 as a reference. The playback module 434 applies display-domain formatting to reconcile any resolution or format difference at the join point. The formatting uses fields in the frame header 212 and metadata in the picture payload 219 to drive color processing, chroma resampling, and spatial scaling.

The playback module 434 aligns audio-video synchronization by snapping presentation timing to the presentation timestamp of the random access switch frame 250 and by applying the service policy tolerance for initial skew. The playback module 434 then continues presentation in display order from the random access point and exposes the random access point for analytics or manifest alignment.

### Method Diagrams

FIG. 5 illustrates a flow diagram of a method 500 for generation of a generalized switch frame 210 and a random access switch frame 250 within a bitstream 312 of an encoder 150, according to various embodiments. Although the method steps are described in conjunction with the systems of FIGS. 1-, persons skilled in the art will understand that any system configured to perform the method steps, in any order, is within the scope of the present disclosure.

As shown in FIG. 5, the method 500 begins at step 502, where an encoder 150 receives an input stream 310 and streaming constraints, which include an encode policy and a service policy that hold information for frame placement, encodes (e.g., bitrate and resolution), and switch cadence.

At step 504, a switch point selector module 320 analyzes the input stream 310 and the streaming constraints to insert a switch frame. The switch point selector module 320 analyzes picture metrics, the encode policy, and the service policy included in the streaming constraints to identify points in the input stream 310 that benefit from switch points and/or random access points. The switch point selector module 320 determines whether the generalized switch frame 210 or the random access switch frame 250 is needed, based on the streaming constraints.

At step 506, based on the decision of the switch point selector module 320, the method 500 proceeds to step 508 if the generalized switch frames 210 are selected. If the random access switch frame 250 is selected, then the method 500 proceeds to step 516.

At step 508, if the generalized switch frame 210 is selected, then the switch point selector module 320 inserts signaling in a frame header 212 to mark the frame type 216 as the generalized switch frame 210. The switch point selector module 320 generates a frame header 212 and sets a frame type 216 to the generalized switch frame 210.

At step 510, a flag module 322 selects frames to preserve at the switch point and generates refresh frame flags 214 to indicate a refresh of non-reference frames in the DPB 204. Further, the flag module 322 embeds a decoder contexts reset 217 into the frame header 212. This ensures that stale references are discarded while chosen references remain available for inter prediction.

At step 512, a frame reference module 324 generates frame references 218 to preserve at the switch point. The selection may include keyframes 260, interframes 270, intra-only frames 280, or non-shown frames retained in DPB slots.

At step 514, the payload generator module 325 generates the picture payload 219 for the generalized switch frame 210. The picture payload 219 includes compressed picture data, including tile data, motion vectors, prediction modes, quantized transform coefficients, residual symbols, and loop filter directives.

At step 516, if the random access switch frame 250 is selected, then the switch point selector module 320 inserts signaling in the frame header 212 to mark the frame type 216 as the random access switch frame 250. The switch point selector module 320 generates the frame header 212 and sets the frame type 216 to the random access switch frame 250.

At step 518, the flag module 322 selects a dependency keyframe 260 to preserve at the switch point and generates the refresh frame flags 214 to indicate refresh of all DPB slots except for the slots associated with the dependency keyframe 260 in the DPB 204. Furthermore, the flag module 322 embeds the decoder contexts reset 217 into the frame header 212, thereby ensuring that stale references are discarded while chosen references remain available for inter prediction.

At step 520, the frame reference module 324 generates a dependency keyframe reference 252, which points to the dependency keyframe 260 in the DPB such that the random access switch frame 250 relies on the dependency keyframe 260 for inter prediction.

At step 522, the payload generator module 325 generates the picture payload 219 for the random access switch frame 250. The picture payload 219 encapsulates compressed symbols for the current switch frame while restricting prediction to the single DPB slot designated by the dependency keyframe reference 252. In some embodiments, if resolution differences exist between the dependency keyframe 260 and the random access switch frame 250, then scaling parameters are inserted into the payload to ensure correct motion-compensated prediction.

At step 524, the bitstream writer module 326 packages and encodes the switch frame (e.g., the generalized switch frame 210 or the random access switch frame 250) into the encoded bitstream 312. The output includes the generalized switch frames 210 or the random access switch frames 250 inserted at the designated switch point. The bitstream writer module 326 assembles the frame header 212 with the refresh frame flags 214 and the frame references 218 or the dependency keyframe reference 252, the picture payload 219, the decoder context reset 217, and any associated fields. In some embodiments, the bitstream writer module 326 also incorporates ordering directives, resolution metadata, and cross-bitstream indicators.

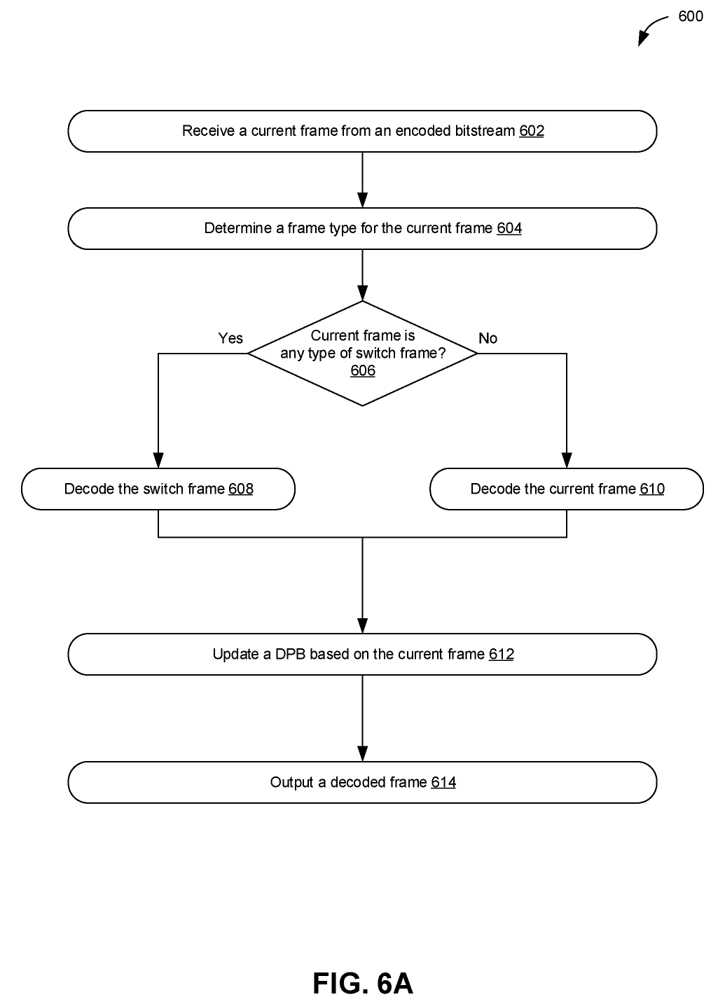

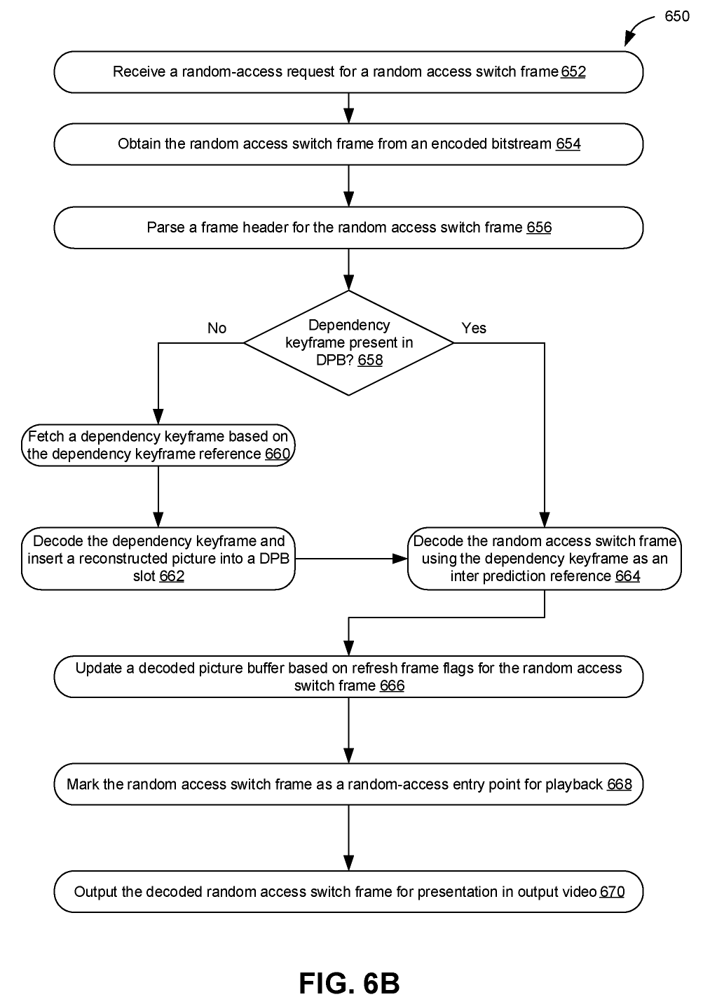

FIG. 6A illustrates a flow diagram of a method 600 for decoding of a generalized switch frame 210 and a random access switch frame 250 via a decoder 160, according to various embodiments. Although the method steps are described in conjunction with the systems of FIGS. 1-4, persons skilled in the art will understand that any system configured to perform the method steps, in any order, is within the scope of the present disclosure.

As shown in FIG. 6A, the method 600 begins with step 602. At step 602, the decoder 160 receives a current frame from an encoded bitstream 312. A bitstream parser module 420 extracts a frame header 212, including fields such as a frame type 216, a picture payload 219 (and if present in the frame header 212), refresh frame flags 214, decoder contexts reset 217, and a frame references 218 or dependency keyframe reference 252.

At step 604, a bitstream parser module 420 determines the frame type 216 for the current frame. Determining the frame type 216 serves to identify whether the current frame is the generalized switch frame 210, a random access switch frame 250, a keyframe 260, an inter frame 270, or an intra-only frame 280.

Step 606 involves evaluating the frame type 216 to determine whether the current frame is a switch frame. If the frame type 216 is not a switch frame (e.g., not the generalized switch frame 210 and not the random access switch frame 250), then the method 600 continues to step 610. Conversely, if the frame type 216 is a switch frame (e.g., the generalized switch frame 210 or the random access switch frame 250), then the method 600 continues to step 608.

At step 608, the frame decode module 430 decodes the switch frame – which, in some embodiments, is also a random access switch frame 250 – by executing reconstruction of the switch frame. As described herein, reconstruction of the switch frame is executed using inter prediction from decoded picture buffer slots of the decoded picture buffer 204 that persist across a switch boundary. The frame decode module 430 decodes frame references to identify decoded picture buffer slots that remain valid for prediction when the switch frame corresponds to a generalized switch frame 210, or a random access switch frame 250 during switching. The frame decode module 430 selects reconstructed pictures stored in such decoded picture buffer slots as inter prediction references and decodes information from the picture payload 219. In this manner, decoding of the switch frame involves utilizing decoded picture buffer contents that persist across the switch boundary without requiring retrieval or decoding of additional reference pictures. The method 600 then continues to step 612.

At step 610, the frame decode module 430 decodes the current frame as another type of frame, such as the keyframe 260, the inter frame 270, or the intra-only frame 280. For the keyframe 260, reconstruction relies solely on intra prediction. For the inter frame 270, the frame decode module 430 applies inter prediction from DPB slots, and the intra-only frame 280 uses intra prediction without a full state reset.

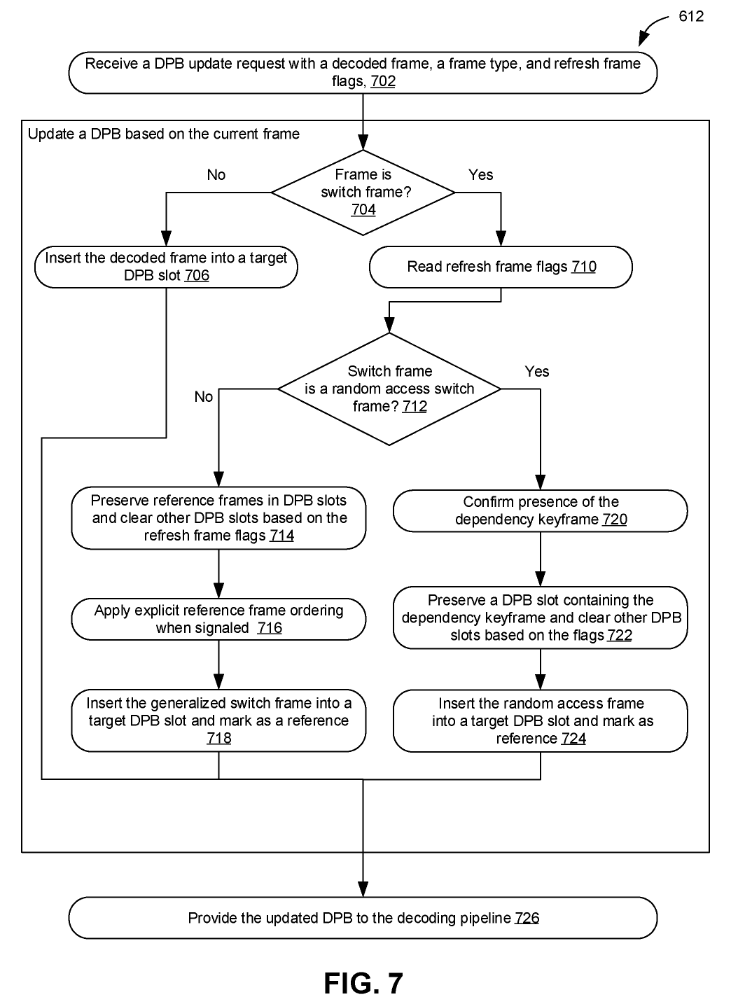

At step 612, depending on the current frame, the DPB updater module 432 applies the refresh frame flags 214 as discussed in greater detail in FIG. 7. Depending on the frame type, such an application of the refresh frame flags 214 may involve retaining selected slots, clearing others, enforcing explicit ordering, and inserting the reconstructed frame into the appropriate DPB slot.

At step 614, a playback module 434 outputs the decoded frame. The playback module 434 presents the reconstructed picture from the current frame as part of output video 450. Such a presentation includes formatting operations such as color conversion, scaling, and synchronization with audio, which promotes the correct presentation to the endpoint device 115.

FIG. 6B illustrates a flow diagram of a method 650 for decoding a random access switch frame 250 at a random access point, according to various embodiments. Although the method steps are described in conjunction with the systems of FIGS. 1-4, persons skilled in the art will understand that any system configured to perform the method steps, in any order, is within the scope of the present disclosure.

As shown in FIG. 6B, the method 650 begins with step 652. At step 652, the decoder 160 receives a random access request for a random access switch frame 250. The random access request corresponds to a request to begin decoding at a location in an encoded bitstream. The random access request can originate based on a user request to seek to a new playback position or based on a decoder 160 operation to initiate decoding at a random access point.

At step 654, the decoder 160 obtains the random access switch frame 250 from the encoded bitstream 312. The decoder 160 identifies data for the random access switch frame 250.

At step 656, the bitstream parser module 420 parses a frame header 212 for the random access switch frame 250. The bitstream parser module 420 extracts the dependency keyframe reference 252 to determine subsequent reference picture usage and decoded picture buffer updates.

At step 658, the decoder 160 determines whether a dependency keyframe 260 referenced by the dependency keyframe reference 252 is present in the decoded picture buffer. The decoder 160 compares the dependency keyframe reference 252 with identifiers of reconstructed pictures stored in the decoded picture buffer slots of the decoded picture buffer 204. If the dependency keyframe 260 is present, then the method 650 continues to step 664. Otherwise, the method 650 continues to step 660.

At step 660, the decoder 160 fetches a dependency keyframe 260 based on the dependency keyframe reference 252. In some embodiments, the decoder 160 retrieves encoded frame data for the dependency keyframe 260 so that the dependency keyframe 260 is available for decoding in subsequent steps of method 650.

At step 662, a frame decode module 430 decodes the dependency keyframe 260 and inserts a reconstructed picture corresponding to the dependency keyframe 260 into the DPB slot of the DPB 204 as, in some embodiments, a non-shown reference. The DPB updater module 432 stores the reconstructed picture in the decoded picture buffer slot indicated by the dependency keyframe reference 252. Further, the RA keyframe decode module 428 prepares the DPB 204 without inserting the random access switch frame 250, and the random access switch frame 250 remains absent from the DPB 204 until a later DPB update for the random access switch frame 250.

At step 664, the frame decode module 430 decodes the random access switch frame 250 using the dependency keyframe 260 as an inter prediction reference. The frame decode module 430 identifies a decoded picture buffer slot of the decoded picture buffer that stores the reconstructed picture corresponding to the dependency keyframe 260. The frame decode module 430 generates a reconstructed picture for the random access switch frame 250 based on prediction data and encoded data of the random access switch frame 250. The frame decode module 430 then reconstructs the random access switch frame 250.

At step 666, the DPB updater module 432 updates the decoded picture buffer 204 based on refresh frame flags 214 for the random access switch frame 250. The refresh frame flags 214 specify which decoded picture buffer slots of the decoded picture buffer are overwritten by the reconstructed picture for the random access switch frame 250. The DPB updater module 432 preserves the DPB slot associated with the reconstructed picture of the dependency keyframe 260 so that the reconstructed picture remains available as a long-term reference for subsequent decoded frames.

At step 668, the decoder 160 marks the random access switch frame 250 as a random access point for playback. The decoder 160 associates an entry-point indicator with the reconstructed picture generated at step 664. The entry-point indicator enables a start of video playback from the reconstructed picture without decoding earlier frames. The entry-point indicator also enables a transition from a non-synchronized playback position to a synchronized playback position in the output video 450.

At step 670, the decoder 160 outputs the reconstructed picture for the random access switch frame 250 for presentation in output video 450. The decoder 160 transmits decoded picture data for the reconstructed picture for rendering.

FIG. 7 illustrates a flow diagram of a method 620 for updating a DPB 204 based on a current frame, according to various embodiments. Although the method steps are described in conjunction with the systems of FIGS. 1-4, persons skilled in the art will understand that any system configured to perform the method steps, in any order, is within the scope of the present invention.

As shown in FIG. 7, the method 620 begins with step 702. At step 702, the DPB updater module 432 receives a DPB update request that includes a decoded frame, a frame type 216, and, in some embodiments, refresh frame flags 214.

At step 704, the DPB updater module 432 determines whether the frame type 216 identifies a switch frame, such as a generalized switch frame 210 or a random access switch frame 250. If the frame type 216 indicates a keyframe 260, an inter frame 270, or an intra-only frame 280, then the method 620 continues to step 706. If the frame type 216 indicates a switch frame, then the DPB updater module 432 continues to step 710.

At step 706, the DPB updater module 432 inserts the decoded frame, such as a reconstructed picture, into a target DPB slot selected according to the frame header 212 and policy rules. The DPB updater module 432 writes per-slot metadata that includes, in some embodiments, a display status, the presentation timestamp, the resolution, and the color attributes. The DPB updater module 432 leaves other DPB slots unchanged to preserve previously reconstructed references.

At step 710, the DPB updater module 432 reads the refresh frame flags 214. In some embodiments, the DPB updater module 432 also reads frame reference 218 or a dependency keyframe reference 252. Based on the refresh frame flags 214 and the frame references 218 or the dependency keyframe reference 252, the DPB updater module 432 derives a preserve set and a refresh set of DPB slots. In some embodiments, a value of the refresh frame flags set to 0xFF indicates a full refresh of all slots of the DPB 204.

At step 712, the DPB updater module 432 determines whether the switch frame is the random access switch frame 250. If the switch frame is the random access switch frame 250, then the method 620 continues to step 720. If the switch frame is not the random access switch frame 250, such as when the switch frame is the generalized switch frame 210, then the method 620 continues to step 714.

At step 714, the DPB updater module 432 preserves the frame references 218 in DPB slots, such as the preserve set, and clears other DPB slots based on the refresh frame flags 214. The DPB updater module 432 invalidates reference-availability for each slot in the refresh set and clears associated per-slot metadata so that obsolete reconstruction handles are not reused.

At step 716, the DPB updater module 432 applies explicit reference frame ordering when signaled. The DPB updater module 432 applies the ordering from the frame references 218 after preservation has been completed. The DPB updater module 432 ensures that a given reference index resolves to the same reconstructed picture across encodes and does not move pixel data.

At step 718, the DPB updater module 432 inserts the generalized switch frame 210 into a target DPB slot and marks the decoded frame (e.g., reconstructed picture) as a reference for later inter prediction. This designation ensures that the generalized switch frame 210 is available as an anchor for inter prediction by later frames that cross the switch boundary, extending its utility beyond display into predictive coding. The DPB updater module 432 records the frame type 216, the presentation timestamp, and format attributes so subsequent frames that span the switch boundary can reference the generalized switch frame 210.

At step 720, the DPB updater module 432 confirms the presence of the dependency keyframe 260 identified by the dependency keyframes reference 252. The DPB updater module 432 verifies the DPB slot identity, the timestamp, and the format. No decoding occurs during this confirmation because the RA keyframe decode module 428 previously guaranteed availability.

At step 722, the DPB updater module 432 preserves the DPB slot that stores the dependency keyframe 260 and clears other DPB slots according to the refresh frame flags 214. If explicit ordering is signaled, then the DPB updater module 432 places the dependency keyframe 260 in the canonical reference position required for subsequent prediction.

At step 724, the DPB updater module 432 inserts the random access switch frame 250 into a target DPB slot and marks the random access switch frame 250 reconstructed picture as a reference. Marking as a reference sets per-slot metadata of the DPB 204, including a reference-availability flag, so future frames can copy prediction blocks from the random access switch frame 250 until the random access switch frame 250 is later cleared by refresh frame flags 214.

At step 726, the DPB updater module 432 provides the updated DPB 204 to the decoding pipeline for a next decode cycle and to a playback module 434. The DPB updater module 432 exposes the revised index mapping and per-slot metadata and hands the decoded frame (e.g., reconstructed picture) in the DPB 204 to the output video 450 for presentation that is synchronized by the presentation timestamp.

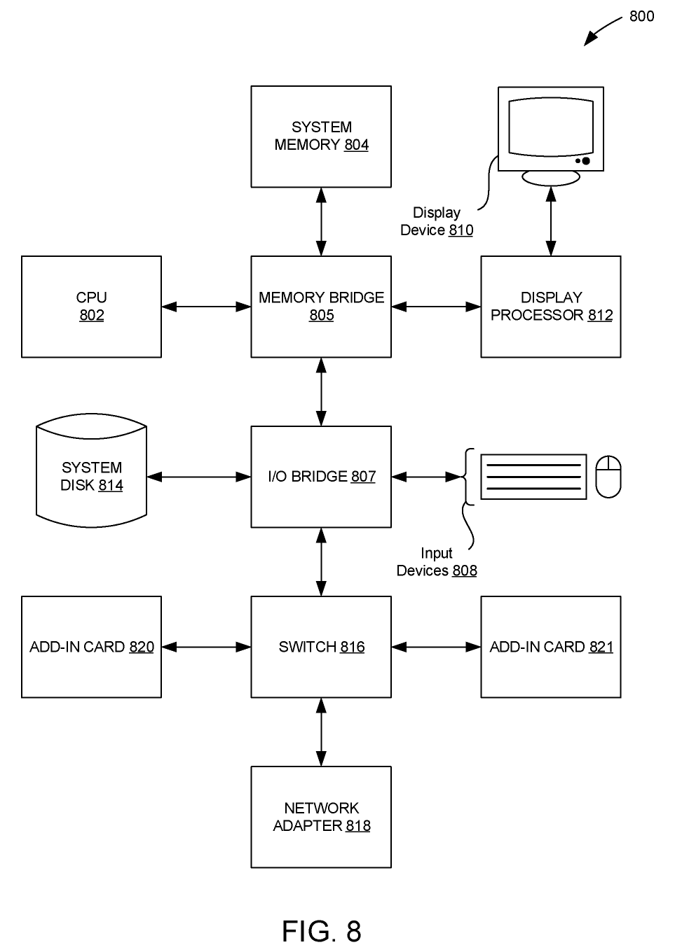

FIG. 8 is a more detailed illustration of a computing device that can implement the functionalities of the entities illustrated in FIG. 1, according to various embodiments. This figure in no way limits or is intended to limit the scope of the various embodiments. In various implementations, system 800 may be an augmented reality, virtual reality, or mixed reality system or device, a personal computer, video game console, personal digital assistant, mobile phone, mobile device or any other device suitable for practicing the various embodiments. Further, in various embodiments, any combination of two or more systems 800 may be coupled together to practice one or more aspects of the various embodiments.

As shown, system 800 includes a central processing unit (CPU) 802 and a system memory 804 communicating via a bus path that may include a memory bridge 805. CPU 802 includes one or more processing cores, and, in operation, CPU 802 is the master processor of system 800, controlling and coordinating operations of other system components. System memory 804 stores software applications and data for use by CPU 802. CPU 802 runs software applications and optionally an operating system. Memory bridge 805, which may be, e.g., a Northbridge chip, is connected via a bus or other communication path (e.g., a HyperTransport link) to an I/O (input/output) bridge 807. I/O bridge 807, which may be, e.g., a Southbridge chip, receives user input from one or more user input devices 808 (e.g., keyboard, mouse, joystick, digitizer tablets, touch pads, touch screens, still or video cameras, motion sensors, and/or microphones) and forwards the input to CPU 802 via memory bridge 805.

A display processor 812 is coupled to memory bridge 805 via a bus or other communication path (e.g., a PCI Express, Accelerated Graphics Port, or HyperTransport link); in one embodiment display processor 812 is a graphics subsystem that includes at least one graphics processing unit (GPU) and graphics memory. Graphics memory includes a display memory (e.g., a frame buffer) used for storing pixel data for each pixel of an output image. Graphics memory can be integrated in the same device as the GPU, connected as a separate device with the GPU, and/or implemented within system memory 804.

Display processor 812 periodically delivers pixels to a display device 810 (e.g., a screen or conventional CRT, plasma, OLED, SED or LCD based monitor or television). Additionally, display processor 812 may output pixels to film recorders adapted to reproduce computer generated images on photographic film. Display processor 812 can provide display device 810 with an analog or digital signal. In various embodiments, one or more of the various graphical user interfaces set forth in FIG. 3 are displayed to one or more users via display device 810, and the one or more users can input data into and receive visual output from those various graphical user interfaces.

A system disk 814 is also connected to I/O bridge 807 and may be configured to store content and applications and data for use by CPU 802 and display processor 812. System disk 814 provides non-volatile storage for applications and data and may include fixed or removable hard disk drives, flash memory devices, and CD-ROM, DVD-ROM, Blu-ray, HD-DVD, or other magnetic, optical, or solid state storage devices.

A switch 816 provides connections between I/O bridge 807 and other components such as a network adapter 818 and various add-in cards 820 and 821. Network adapter 818 allows system 800 to communicate with other systems via an electronic communications network, and may include wired or wireless communication over local area networks and wide area networks such as the Internet.

Other components (not shown), including USB or other port connections, film recording devices, and the like, may also be connected to I/O bridge 807. For example, an audio processor may be used to generate analog or digital audio output from instructions and/or data provided by CPU 802, system memory 804, or system disk 814. Communication paths interconnecting the various components in FIG. 8 may be implemented using any suitable protocols, such as PCI (Peripheral Component Interconnect), PCI Express (PCI-E), AGP (Accelerated Graphics Port), HyperTransport, or any other bus or point-to-point communication protocol(s), and connections between different devices may use different protocols, as is known in the art.

In one embodiment, display processor 812 incorporates circuitry optimized for graphics and video processing, including, for example, video output circuitry, and constitutes a graphics processing unit (GPU). In another embodiment, display processor 812 incorporates circuitry optimized for general purpose processing. In yet another embodiment, display processor 812 may be integrated with one or more other system elements, such as the memory bridge 805, CPU 802, and I/O bridge 807 to form a system on chip (SoC). In still further embodiments, display processor 812 is omitted and software executed by CPU 802 performs the functions of display processor 812.

Pixel data can be provided to display processor 812 directly from CPU 802. In some embodiments, instructions and/or data representing a scene are provided to a render farm or a set of server computers, each similar to system 800, via network adapter 818 or system disk 814. The render farm generates one or more rendered images of the scene using the provided instructions and/or data. These rendered images may be stored on computer-readable media in a digital format and optionally returned to system 800 for display. Similarly, stereo image pairs processed by display processor 812 may be output to other systems for display, stored in system disk 814, or stored on computer-readable media in a digital format.

Alternatively, CPU 802 provides display processor 812 with data and/or instructions defining the desired output images, from which display processor 812 generates the pixel data of one or more output images, including characterizing and/or adjusting the offset between stereo image pairs. The data and/or instructions defining the desired output images can be stored in system memory 804 or graphics memory within display processor 812. In an embodiment, display processor 812 includes 3D rendering capabilities for generating pixel data for output images from instructions and data defining the geometry, lighting shading, texturing, motion, and/or camera parameters for a scene. Display processor 812 can further include one or more programmable execution units capable of executing shader programs, tone mapping programs, and the like.

Further, in other embodiments, CPU 802 or display processor 812 may be replaced with or supplemented by any technically feasible form of processing device configured process data and execute program code. Such a processing device could be, for example, a central processing unit (CPU), a graphics processing unit (GPU), an application-specific integrated circuit (ASIC), a field-programmable gate array (FPGA), and so forth. In various embodiments any of the operations and/or functions described herein can be performed by CPU 802, display processor 812, or one or more other processing devices or any combination of these different processors.

CPU 802, render farm, and/or display processor 812 can employ any surface or volume rendering technique known in the art to create one or more rendered images from the provided data and instructions, including rasterization, scanline rendering REYES or micropolygon rendering, ray casting, ray tracing, image-based rendering techniques, and/or combinations of these and any other rendering or image processing techniques known in the art.

In other contemplated embodiments, system 800 may be a robot or robotic device and may include CPU 802 and/or other processing units or devices and system memory 804. In such embodiments, system 800 may or may not include other elements shown in FIG. 8. System memory 804 and/or other memory units or devices in system 800 may include instructions that, when executed, cause the robot or robotic device represented by system 800 to perform one or more operations, steps, tasks, or the like.

It will be appreciated that the system shown herein is illustrative and that variations and modifications are possible. The connection topology, including the number and arrangement of bridges, may be modified as desired. For instance, in some embodiments, system memory 804 is connected to CPU 802 directly rather than through a bridge, and other devices communicate with system memory 804 via memory bridge 805 and CPU 802. In other alternative topologies display processor 812 is connected to I/O bridge 807 or directly to CPU 802, rather than to memory bridge 805. In still other embodiments, I/O bridge 807 and memory bridge 805 might be integrated into a single chip. The particular components shown herein are optional; for instance, any number of add-in cards or peripheral devices might be supported. In some embodiments, switch 816 is eliminated, and network adapter 818 and add-in cards 820, 821 connect directly to I/O bridge 807.

In sum, techniques are disclosed for implementing generalized switch frames, also referred to herein as switch frames, within a streaming pipeline that includes an encoder and a decoder. The encoder generates a bitstream that includes generalized switch frames and random access switch frames at designated switch points across encodes. The generalized switch frame includes a preservation flag that enables explicit DPB update control by identifying reference frames to preserve and reference frames to refresh across a switch point. The random access switch frame enables random access playback at the switch point by relying on a keyframe as a reference.

The encoder selects switch points, designates each switch point to use the generalized switch frame or the random access switch frame, sets a preservation flag, and coordinates preserved reference frames across the encodes to maintain consistent DPB states. The encoder writes signaling in the bitstream that identifies a frame type and carries the preservation flag. The decoder receives the bitstream, parses the signaling for a current frame, and decodes the current frame using reference frames or keyframes indicated by signaling information carried by the switch frame. The decoder then updates the DPB according to the current frame type. For a normal frame, the decoder inserts the decoded frame according to a normal update policy. For the generalized switch frame, the decoder applies the preservation flag to preserve specified reference frames, refreshes remaining DPB entries, and inserts the decoded frame according to a generalized switch frame policy. For the random access switch frame, the decoder obtains and decodes the dependency keyframe, applies the preservation flag to preserve the dependency keyframe, and inserts the decoded random access switch frame according to a random access policy.

At least one technical advantage of the disclosed techniques relative to the prior art is that the disclosed techniques enable DPB update control at switch points by the encoder. Explicit DPB update control by the encoder allows for a preservation of selected reference frames across the switch point and avoids discarding non-shown reference frames. Preservation of reference frames reduces network bandwidth consumption and reduces processing load on the encoder and the decoder. Another technical advantage of the disclosed techniques over the prior art is that the disclosed techniques maintain consistent DPB states across encodes at switch points. Consistent DPB states prevent mismatched reference frames during a transition between encodes, which avoids visible artifacts during stream switching and increases reliability across encodes.

A further technical advantage of the disclosed techniques is that the disclosed techniques provide random access points that do not rely only on keyframes. Additional random access points improve video startup behavior and video seeking behavior without increasing the frequency of keyframes in the encode, which reduces network bandwidth consumption during playback. An additional technical advantage of the disclosed techniques is that the disclosed techniques simplify decoder management of the DPB by shifting update decisions to the encoder. Shifting DPB update decisions to the encoder ensures uniform DPB updates across decoders for a given encode, which increases reliability and reduces error propagation after a switch point.

These technical advantages represent one or more technological advancements over prior art approaches.
1. In some embodiments, a computer-implemented method for encoding switch frames in a bitstream comprises: determining a plurality of switch points for transition between a plurality of encodes included in a video stream; and for each switch point included in the plurality of switch points: encoding a switch frame that includes explicit signaling defining reference-frame preservation across the switch point; and inserting the switch frame into the bitstream to cause a decoder receiving the bitstream to apply the explicit signaling to update a decoded picture buffer in accordance with the defined reference-frame preservation.
2. The computer-implemented method of clause 1, wherein each switch frame comprises a generalized switch frame that enables selective preservation of reference frames across the switch point while permitting inter prediction from preserved reference frames.
3. The computer-implemented method of any of clauses 1-2, wherein each switch frame comprises a random access switch frame that depends on a keyframe for decoding and enables random access playback at the switch point.
4. The computer-implemented method of any of clauses 1-3, wherein each random access switch frame includes a dependency keyframe reference that identifies a keyframe to be preserved across the switch point for inter prediction of the random access switch frame.
5. The computer-implemented method of any of clauses 1-4, wherein encoding each switch frame comprises setting one or more preservation flags that explicitly identify reference frames to preserve and reference frames to refresh across the switch point.
6. The computer-implemented method of any of clauses 1-5, further comprising coordinating the explicit signaling for reference-frame preservation across the plurality of encodes to maintain consistent decoded picture buffer states at corresponding switch points.
7. The computer-implemented method of any of clauses 1-6, wherein encoding each switch frame further comprises embedding, within the switch frame, signaling that identifies a frame type corresponding to the switch frame and a decoder-contexts-reset indicator that directs the decoder to reset adaptive decoding contexts.
8. The computer-implemented method of any of clauses 1-7, wherein the explicit signaling defining reference-frame preservation comprises disabling short-reference signaling to enforce explicit reference ordering and to enforce cross-encode determinism across the plurality of encodes.
9. The computer-implemented method of any of clauses 1-8, wherein encoding each switch frame comprises generating syntax that identifies the switch frame through a frame-type field or an open-bitstream-unit type compatible with a video-coding standard.
10. The computer-implemented method of any of clauses 1-9, wherein determining the plurality of switch points and encoding a switch frame for each switch point included in the plurality of switch points are performed based at least in part on an encode policy and a service policy that specify at least one of switching frequency, quality thresholds, and acceptable drift tolerance.
11. In some embodiments, one or more non-transitory computer-readable storage media storing instructions that, when executed by one or more processors, cause the one or more processors to encode switch frames in a bitstream, by performing the operations of: determining a plurality of switch points for transition between a plurality of encodes included in a video stream; and for each switch point included in the plurality of switch points: encoding a switch frame that includes explicit signaling defining reference-frame preservation across the switch point; and inserting the switch frame into the bitstream to cause a decoder receiving the bitstream to apply the explicit signaling to update a decoded picture buffer in accordance with the defined reference-frame preservation.
12. The one or more non-transitory computer-readable storage media of clause 11, wherein encoding each switch frame further comprises inserting, into the bitstream, metadata identifying a drift-tolerance threshold that defines an acceptable level of visual divergence following a transition between encodes.
13. The one or more non-transitory computer-readable storage media of any of clauses 11-12, wherein encoding each switch frame comprises including, within the switch frame, resolution information that enables a decoder to perform upscaling or downscaling when a reference frame and the switch frame differ in spatial resolution.
14. The one or more non-transitory computer-readable storage media of any of clauses 11-13, wherein encoding each switch frame comprises generating loop-filter control data or restoration syntax that directs the decoder to apply in-loop filtering or restoration operations.
15. The one or more non-transitory computer-readable storage media of any of clauses 11-14, wherein each switch frame comprises a generalized switch frame that enables selective preservation of reference frames across the switch point while permitting inter prediction from preserved reference frames.
16. The one or more non-transitory computer-readable storage media of any of clauses 11-15, wherein each switch frame comprises a random access switch frame that depends on a keyframe for decoding and enables random access playback at the switch point.
17. The one or more non-transitory computer-readable storage media of any of clauses 11-16, wherein each random access switch frame includes a dependency keyframe reference that identifies a keyframe to be preserved across the switch point for inter prediction of the random access switch frame.
18. The one or more non-transitory computer-readable storage media of any of clauses 11-17, wherein encoding each switch frame comprises setting one or more preservation flags that explicitly identify reference frames to preserve and reference frames to refresh across the switch point.
19. The one or more non-transitory computer-readable storage media of any of clauses 11-18, further comprising coordinating the explicit signaling for reference-frame preservation across the plurality of encodes to maintain consistent decoded picture buffer states at corresponding switch points.
20. In some embodiments, a computer system comprises one or more memories that include instructions, and one or more processors that are coupled to the one or more memories and that, when executing the instructions, are configured to encode switch frames in a bitstream, by performing the operations of: determining a plurality of switch points for transition between a plurality of encodes included in a video stream, and for each switch point included in the plurality of switch points: encoding a switch frame that includes explicit signaling defining reference-frame preservation across the switch point, and inserting the switch frame into the bitstream to cause a decoder receiving the bitstream to apply the explicit signaling to update a decoded picture buffer in accordance with the defined reference-frame preservation.
21. In some embodiments, a computer-implemented method for decoding switch frames included in a bitstream comprises: receiving a bitstream that includes a plurality of switch frames, each switch frame comprising explicit signaling defining reference-frame preservation information across a corresponding switch point; and for each switch frame included in the plurality of switch frames: parsing the explicit signaling included in the switch frame to identify reference frames to be preserved and reference frames to be refreshed across the corresponding switch point; and updating a decoded picture buffer in accordance with the identified reference frames to be preserved and the identified reference frames to be refreshed.
22. The computer-implemented method of clause 21, further comprising detecting each switch frame included in the plurality of switch frames by reading signaling included in a frame header of each switch frame that identifies a frame type corresponding to the switch frame.
23. The computer-implemented method of any of clauses 21-22, wherein updating the decoded picture buffer based on the explicit signaling further comprises applying one or more preservation flags that explicitly specify persistence of reference frames across the corresponding switch point.
24. The computer-implemented method of any of clauses 21-23, wherein each switch frame comprises a generalized switch frame, and updating the decoded picture buffer for each generalized switch frame comprises preserving reference frames identified by the explicit signaling while refreshing remaining reference frames.
25. The computer-implemented method of any of clauses 21-24, wherein each switch frame comprises a random access switch frame that depends on a keyframe for decoding, and updating the decoded picture buffer for each random access switch frame comprises preserving a dependency keyframe reference and refreshing remaining reference frames.
26. The computer-implemented method of any of clauses 21-25, further comprising decoding each dependency keyframe reference prior to decoding the corresponding random access switch frame to ensure that the dependency keyframe reference is available for inter prediction.
27. The computer-implemented method of any of clauses 21-26, wherein parsing the explicit signaling further comprises enforcing explicit reference ordering to ensure that equivalent reference-frame indices correspond to equivalent reconstructed pictures across encodes.
28. The computer-implemented method of any of clauses 21-27, further comprising resetting decoding contexts based on a decoder-contexts-reset indicator included in each switch frame to ensure deterministic decoding behavior at the corresponding switch point.
29. The computer-implemented method of any of clauses 21-28, further comprising marking a random access point in an output video when the corresponding switch frame comprises a random access switch frame, thereby identifying a safe entry location for playback or mid-stream join operations.
30. The computer-implemented method of any of clauses 21-29, further comprising reconstructing and presenting decoded pictures derived from the plurality of switch frames in display order in accordance with presentation timestamps included in the bitstream.
31. In some embodiments, one or more non-transitory computer-readable storage media storing instructions that, when executed by one or more processors, cause the one or more processors to decode switch frames included in a bitstream, by performing the operations of: receiving a bitstream that includes a plurality of switch frames, each switch frame comprising explicit signaling defining reference-frame preservation information across a corresponding switch point; and for each switch frame included in the plurality of switch frames: parsing the explicit signaling included in the switch frame to identify reference frames to be preserved and reference frames to be refreshed across the corresponding switch point; and updating a decoded picture buffer in accordance with the identified reference frames to be preserved and the identified reference frames to be refreshed.
32. The one or more non-transitory computer-readable storage media of clause 31, further comprising interpreting drift-tolerance information included in each switch frame to control application of corrective decoding operations when visual divergence following a transition between encodes exceeds a defined drift threshold.
33. The one or more non-transitory computer-readable storage media of any of clauses 31-32, wherein parsing the explicit signaling further comprises reading resolution information included in each switch frame and applying upscaling or downscaling to a reconstructed picture when a referenced frame and the switch frame differ in spatial resolution.
34. The one or more non-transitory computer-readable storage media of any of clauses 31-33, wherein reconstructing the decoded pictures further comprises applying in-loop filtering or restoration operations directed by loop-filter control data or restoration syntax included in each switch frame to enhance visual quality of the reconstructed pictures following the corresponding switch point.
35. The one or more non-transitory computer-readable storage media of any of clauses 31-34, further comprising detecting each switch frame included in the plurality of switch frames by reading signaling included in a frame header of each switch frame that identifies a frame type corresponding to the switch frame.
36. The one or more non-transitory computer-readable storage media of any of clauses 31-35, wherein updating the decoded picture buffer based on the explicit signaling further comprises applying one or more preservation flags that explicitly specify persistence of reference frames across the corresponding switch point.
37. The one or more non-transitory computer-readable storage media of any of clauses 31-36, wherein each switch frame comprises a generalized switch frame, and updating the decoded picture buffer for each generalized switch frame comprises preserving reference frames identified by the explicit signaling while refreshing remaining reference frames.
38. The one or more non-transitory computer-readable storage media of any of clauses 31-37, wherein each switch frame comprises a random access switch frame that depends on a keyframe for decoding, and updating the decoded picture buffer for each random access switch frame comprises preserving a dependency keyframe reference and refreshing remaining reference frames.
39. The one or more non-transitory computer-readable storage media of any of clauses 31-38, further comprising decoding each dependency keyframe reference prior to decoding the corresponding random access switch frame to ensure that the dependency keyframe reference is available for inter prediction.
40. In some embodiments, a computer system comprises one or more memories that include instructions, and one or more processors that are coupled to the one or more memories and that, when executing the instructions, are configured to decode switch frames included in a bitstream, by performing the operations of: receiving a bitstream that includes a plurality of switch frames, each switch frame comprising explicit signaling defining reference-frame preservation information across a corresponding switch point, and for each switch frame included in the plurality of switch frames: parsing the explicit signaling included in the switch frame to identify reference frames to be preserved and reference frames to be refreshed across the corresponding switch point, and updating a decoded picture buffer in accordance with the identified reference frames to be preserved and the identified reference frames to be refreshed.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a ““module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general-purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for encoding switch frames in a bitstream, the method comprising:
determining a plurality of switch points for transition between a plurality of encodes included in a video stream; and
for each switch point included in the plurality of switch points:
encoding a switch frame that includes explicit signaling defining reference-frame preservation across the switch point; and
inserting the switch frame into the bitstream to cause a decoder receiving the bitstream to apply the explicit signaling to update a decoded picture buffer in accordance with the defined reference-frame preservation.

2. The computer-implemented method of claim 1, wherein each switch frame comprises a generalized switch frame that enables selective preservation of reference frames across the switch point while permitting inter prediction from preserved reference frames.

3. The computer-implemented method of claim 1, wherein each switch frame comprises a random access switch frame that depends on a keyframe for decoding and enables random access playback at the switch point.

4. The computer-implemented method of claim 3, wherein each random access switch frame includes a dependency keyframe reference that identifies a keyframe to be preserved across the switch point for inter prediction of the random access switch frame.

5. The computer-implemented method of claim 1, wherein encoding each switch frame comprises setting one or more preservation flags that explicitly identify reference frames to preserve and reference frames to refresh across the switch point.

6. The computer-implemented method of claim 1, further comprising coordinating the explicit signaling for reference-frame preservation across the plurality of encodes to maintain consistent decoded picture buffer states at corresponding switch points.

7. The computer-implemented method of claim 1, wherein encoding each switch frame further comprises embedding, within the switch frame, signaling that identifies a frame type corresponding to the switch frame and a decoder-contexts-reset indicator that directs the decoder to reset adaptive decoding contexts.

8. The computer-implemented method of claim 1, wherein the explicit signaling defining reference-frame preservation comprises disabling short-reference signaling to enforce explicit reference ordering and to enforce cross-encode determinism across the plurality of encodes.

9. The computer-implemented method of claim 1, wherein encoding each switch frame comprises generating syntax that identifies the switch frame through a frame-type field or an open-bitstream-unit type compatible with a video-coding standard.

10. The computer-implemented method of claim 1, wherein determining the plurality of switch points and encoding a switch frame for each switch point included in the plurality of switch points are performed based at least in part on an encode policy and a service policy that specify at least one of switching frequency, quality thresholds, and acceptable drift tolerance.

11. One or more non-transitory computer-readable storage media storing instructions that, when executed by one or more processors, cause the one or more processors to encode switch frames in a bitstream, by performing the operations of:
determining a plurality of switch points for transition between a plurality of encodes included in a video stream; and
for each switch point included in the plurality of switch points:
encoding a switch frame that includes explicit signaling defining reference-frame preservation across the switch point; and
inserting the switch frame into the bitstream to cause a decoder receiving the bitstream to apply the explicit signaling to update a decoded picture buffer in accordance with the defined reference-frame preservation.

12. The one or more non-transitory computer-readable storage media of claim 11, wherein encoding each switch frame further comprises inserting, into the bitstream, metadata identifying a drift-tolerance threshold that defines an acceptable level of visual divergence following a transition between encodes.

13. The one or more non-transitory computer-readable storage media of claim 11, wherein encoding each switch frame comprises including, within the switch frame, resolution information that enables a decoder to perform upscaling or downscaling when a reference frame and the switch frame differ in spatial resolution.

14. The one or more non-transitory computer-readable storage media of claim 11, wherein encoding each switch frame comprises generating loop-filter control data or restoration syntax that directs the decoder to apply in-loop filtering or restoration operations.

15. The one or more non-transitory computer-readable storage media of claim 11, wherein each switch frame comprises a generalized switch frame that enables selective preservation of reference frames across the switch point while permitting inter prediction from preserved reference frames.

16. The one or more non-transitory computer-readable storage media of claim 11, wherein each switch frame comprises a random access switch frame that depends on a keyframe for decoding and enables random access playback at the switch point.

17. The one or more non-transitory computer-readable storage media of claim 16, wherein each random access switch frame includes a dependency keyframe reference that identifies a keyframe to be preserved across the switch point for inter prediction of the random access switch frame.

18. The one or more non-transitory computer-readable storage media of claim 11, wherein encoding each switch frame comprises setting one or more preservation flags that explicitly identify reference frames to preserve and reference frames to refresh across the switch point.

19. The one or more non-transitory computer-readable storage media of claim 11, further comprising coordinating the explicit signaling for reference-frame preservation across the plurality of encodes to maintain consistent decoded picture buffer states at corresponding switch points.

20. A computer system, comprising:
one or more memories that include instructions; and
one or more processors that are coupled to the one or more memories and, when executing the instructions, are configured to encode switch frames in a bitstream, by performing the operations of:
determining a plurality of switch points for transition between a plurality of encodes included in a video stream; and
for each switch point included in the plurality of switch points:
encoding a switch frame that includes explicit signaling defining reference-frame preservation across the switch point; and
inserting the switch frame into the bitstream to cause a decoder receiving the bitstream to apply the explicit signaling to update a decoded picture buffer in accordance with the defined reference-frame preservation.
